(19) United States
(12) Patent Application Publication
(10) Pub. No.: US 2025/0313346 A1
(43) Pub. Date: Oct. 9, 2025

(54) PILOT FATIGUE DETECTION AND ALERT TECHNOLOGY

(71) Applicants: Anijeet Kanjilal, San Jose, CA (US); Rohit Mekkoth, San Jose, CA (US); Omkar Amol Tasgaonkar, San Jose, CA (US); Tiffany Ly, San Jose, CA (US)

(72) Inventors: Anijeet Kanjilal, San Jose, CA (US); Rohit Mekkoth, San Jose, CA (US); Omkar Amol Tasgaonkar, San Jose, CA (US); Tiffany Ly, San Jose, CA (US)

(21) Appl. No.: 19/170,794

(22) Filed: Apr. 4, 2025

Related U.S. Application Data
(60) Provisional application No. 63/574,414, filed on Apr. 4, 2024.

(51) Int. Cl. B64D 45/00; G06F 3/01; G06V 10/82; G06V 20/59; G06V 40/16; G08G 5/23

(52) U.S. Cl. CPC B64D 45/00; G06F 3/016; G06V 10/82; G06V 20/59; G06V 40/172; G08G 5/23; B64D 2045/0075

(57) ABSTRACT

Examples relate to a fatigue detection system to monitor and assess pilot fatigue levels during flight operations. An example system includes a wearable biometric sensor (WBS) integrated into a wristband that captures biometric data from the pilot. A processor analyzes the captured data to determine the pilot's fatigue level. When this level exceeds a predetermined threshold, the system provides an alert to the pilot through a haptic feedback mechanism in the wristband. Additionally, the system generates personalized fatigue mitigation advice, which is displayed on an electronic flight bag (EFB) application accessible to the pilot. The advice may include recommendations for taking a controlled rest, consuming caffeine, or engaging in physical activity. The system enhances flight safety by providing real-time alerts and actionable advice to combat pilot fatigue.

### CROSS-REFERENCE TO RELATED APPLICATIONS

This application claims the benefit of U.S. Provisional Application No. 63/574,414, filed Apr. 4, 2024, entitled “PILOT FATIGUE DETECTION AND ALERT TECHNOLOGY,” which is incorporated herein by reference in its entirety.

### BACKGROUND

In the field of aviation, pilot fatigue is a significant concern that can compromise the safety of flight operations. Fatigue is recognized by the Federal Aviation Administration (FAA) as a state of reduced mental and physical performance, which can lead to diminished alertness. The consequences of pilot fatigue are severe, as evidenced by its implication in approximately 23% of commercial aviation accidents. High-profile accidents such as Korean Air flight 801 and Air India Express flight 812, which resulted in a combined loss of 387 lives, have been directly attributed to pilot fatigue.

Current regulatory measures, including mandated rest and sleep hours, have been instituted by the FAA and other regulatory bodies to combat the issue of pilot fatigue. However, these measures alone have proven insufficient, as fatigue can arise from a multitude of factors beyond a lack of sleep, such as stress, dietary habits, and workload. Moreover, there is concern regarding the consistent adherence to these regulations by all pilots and airlines.

Existing systems designed to monitor pilot fatigue often fall short in several respects. For instance, they may not account for the multifaceted nature of fatigue, which can be influenced by both physiological and psychological factors. Additionally, current solutions may lack the capability to provide real-time monitoring and feedback for the timely detection and mitigation of fatigue.

Existing systems designed to monitor pilot fatigue have various limitations. Current approaches may not fully account for the multifaceted nature of fatigue or provide timely feedback.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic diagram illustrating the architecture of a fatigue detection system with various components including a wristband with sensors and an electronic flight bag application, according to some examples.

FIG. 2 is a block diagram illustrating a layered view of the architecture of the fatigue detection system, highlighting different layers such as data acquisition, core analysis, and user interface, according to some examples.

FIG. 3 is an isometric view illustrating a camera component of the fatigue detection system, designed to capture facial imagery of a pilot, according to some examples.

FIG. 4 is a side view illustrating the camera component with mounting features for attachment to an electronic flight bag, according to some examples.

FIG. 5 is a cross-sectional view illustrating the internal structure of the camera component, including the battery and circuit board, according to some examples.

FIG. 6 is a top view illustrating the camera assembly and its external features, such as the lens and mounting clip, according to some examples.

FIG. 7 is an isometric view illustrating a wristband that is part of the fatigue detection system, equipped with sensors for monitoring biometric data, according to some examples.

FIG. 8 is a top view illustrating the wristband with adjustment holes and a central sensor housing, according to some examples.

FIG. 9 is a section view taken along the line A-A in FIG. 8, showing the internal structure of the wristband including the sensor box and various components, according to some examples.

FIG. 10 is a front view illustrating the wristband and its features such as the strap and sensor box, according to some examples.

FIG. 11 is a data architecture diagram illustrating the data entities used to support the operations of a fatigue detection system, including tables for system configurations, pilot information, and fatigue events, according to some examples.

FIG. 12 is a flowchart illustrating a method for detecting and responding to pilot fatigue, including operations such as capturing biometric data and providing alerts, according to some examples.

FIG. 13 is a flowchart illustrating a method for fatigue detection and alerting, detailing the process of capturing facial imagery and biometric data, and analyzing them for signs of fatigue, according to some examples.

FIG. 14A and FIG. 14B are flowcharts illustrating a method for fatigue detection and response, showing the sequence of operations from data capture to alerting the pilot, according to some examples.

FIG. 15 is a flowchart illustrating a method for fatigue detection and alerting, outlining steps such as collecting biometric data and providing alerts to the pilot, according to some example

FIG. 16 is a flowchart illustrating a method of fatigue detection and management, depicting the process from capturing facial imagery to displaying fatigue mitigation instructions, according to some examples.

FIG. 17 is a flowchart depicting a machine-learning pipeline, detailing phases such as data collection, model training, and deployment, according to some examples

FIG. 18 is a diagrammatic representation illustrating the training and use of a machine-learning program within a fatigue detection system, according to some examples

FIG. 19 is a block diagram showing a software architecture within which the fatigue detection system may be implemented, according to some examples.

FIG. 20 is a diagrammatic representation of a machine in the form of a computer system within which a set of instructions may be executed for causing the machine to perform any one or more of the methodologies discussed herein, in accordance with some examples.

### DETAILED DESCRIPTION

### Overview

In the aviation industry, pilot fatigue is a significant safety concern due to the demanding nature of the job, which often involves long hours, irregular shifts, and crossing multiple time zones. Fatigue can severely impair a pilot's cognitive functions, reaction times, and overall ability to operate an aircraft safely. Recognizing the need for an effective solution to this pervasive issue, example technical solutions are disclosed below to monitor and detect signs of fatigue in pilots, enhancing flight safety and operational efficiency.

Examples include a fatigue detection system that integrates advanced facial recognition software with biometric sensors. The system is designed to be incorporated into the pilot's standard equipment, such as the electronic flight bag (EFB), which is a digital tool used for managing flight-related tasks and documentation.

The EFB, which may be a ruggedized tablet or laptop, typically includes software applications that assist with navigation, flight planning, performance calculations, and accessing reference materials. By incorporating the fatigue detection system into the EFB, pilots can benefit from a centralized platform that not only aids in flight management but also monitors their well-being.

Example technical implementations of the fatigue detection system within the EFB involves the use of various sensors and cameras that work in conjunction with the EFB's hardware and software. For example, the EFB's processing unit, which may consist of a high-performance CPU and sufficient RAM, is utilized to run the fatigue assessment engine's complex algorithms. The EFB's display, which is designed for high visibility under various lighting conditions, presents fatigue mitigation advice and alerts in a clear and concise manner.

The EFB's connectivity options, such as Wi-Fi, Bluetooth, and cellular networks, enable real-time data synchronization with the airline's operations center. This allows for the transmission of fatigue metrics and the receipt of updated flight information, which the system uses to tailor the fatigue mitigation advice. Additionally, the EFB's internal storage securely retains the pilot's biometric data locally, ensuring privacy and compliance with data protection regulations.

The fatigue detection system may utilize the EFB's built-in sensors, such as accelerometers and gyroscopes, to detect and analyze the pilot's movements and posture as additional indicators of fatigue. The system's software components are designed to be compatible with the EFB's operating system, whether it is iOS, Android, or another platform, allowing for easy updates and maintenance.

A facial recognition component of the system may use a type of artificial intelligence known as a convolutional neural network (CNN). This network analyzes the pilot's facial expressions and eye movements to identify common indicators of fatigue, such as frequent yawning, drooping eyelids, and slow blink rates. These visual cues can provide early warning signs of drowsiness and decreased alertness.

To bolster the detection capabilities, the fatigue detection system includes a wearable device, such as a wristband, equipped with sensors that monitor the pilot's physiological data. These sensors measure heart rate and heart rate variability (HRV), which is the variation in the time interval between heartbeats. Fluctuations in HRV are closely linked to the body's stress response and can be indicative of fatigue. By combining data from both facial analysis and biometric readings, the system can make an accurate assessment of the pilot's state.

For operations in low-light conditions, such as night flights, the fatigue detection system may be augmented with an infrared (IR) camera. This camera enhances the system's ability to capture clear images of the pilot's face and eyes, ensuring accurate fatigue detection even in the absence of adequate lighting.

An artificial intelligence model is trained on a diverse set of data, including images tagged with signs of fatigue. This training allows the model to recognize a wide array of fatigue symptoms with high accuracy. Pilots may choose to contribute their data to help refine the model, which can lead to improved detection rates and a more robust system overall.

Upon detecting signs of fatigue, the fatigue detection system promptly alerts the pilot through a series of gentle vibrations from the wearable device. Concurrently, a message with recommendations on how to counteract fatigue is displayed on the pilot's digital interface. These recommendations are tailored to the specific circumstances of the flight and may include taking a short rest or consuming caffeine, depending on what is feasible and safe under the given conditions.

Privacy is integrated into the technology's design. All biometric data collected for the purpose of fatigue detection is stored locally and not shared with employers or third parties. This ensures that the pilot's privacy is maintained while still providing personalized and accurate fatigue assessments.

The system, according to some examples, employs a scoring mechanism that assigns points to various fatigue indicators based on their significance. Once a predefined point threshold is reached, an alert is triggered, ensuring that only genuine instances of fatigue prompt intervention.

Ease of use is another feature of this technology. Pilots can interact with the fatigue detection system through a simple user interface that requires minimal input, allowing them to focus on their primary responsibilities. The fatigue detection system's software is designed to be intuitive and requires only the flight number to provide customized advice.

This fatigue detection technology offers real-time alerts and actionable advice to combat pilot fatigue. It not only aids pilots in staying alert but also provides valuable data that can be used to optimize work schedules and promote healthier lifestyle choices, thereby reducing the likelihood of fatigue-related incidents.

The wearable device that, in some examples, forms part of the fatigue detection system is distinct in its design and functionality. Unlike other health-monitoring wearables, this device is specifically engineered to interact seamlessly with the fatigue detection software and to provide physical alerts to the wearer.

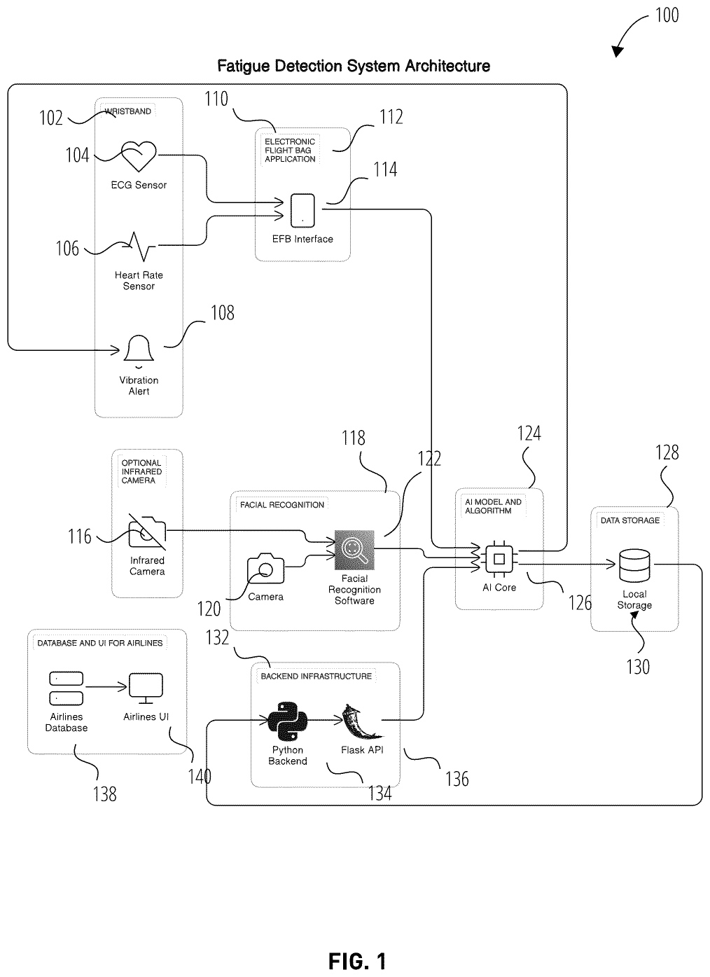

### FIG. 1—System Architecture

FIG. 1 is a schematic diagram showing a conceptual view of an architecture of a fatigue detection system 100, according to some examples. The fatigue detection system 100 is designed to monitor and assess the fatigue levels of pilots during flight operations, utilizing a combination of hardware components and software analytics to provide real-time alerts and mitigation advice.

A wristband 102 is an example wearable biometric sensor (WBS) device equipped with an ECG sensor 104 and a heart rate sensor 106. The ECG sensor 104 is responsible for capturing electrocardiogram data, which is for measuring heart rate variability (HRV), a physiological indicator of fatigue. The heart rate sensor 106 complements this by monitoring the pilot's heart rate, providing additional data points for fatigue assessment.

In the event that the fatigue detection system 100 detects fatigue levels exceeding a predetermined threshold, the vibration alert component 108 within the wristband 102 is activated to provide a tactile alert to the pilot. This alert serves as an immediate notification to the pilot, prompting them to take actions to mitigate fatigue.

In some examples, a wristband 102 may be equipped with a photoplethysmogram (PPG) sensor instead of or in addition to the ECG sensor 104. A PPG sensor uses light-based technology to detect blood volume changes in the microvascular bed of tissue, which can be used to monitor heart rate and other cardiovascular metrics. This non-invasive method can provide continuous heart rate monitoring with less discomfort for the user, making it suitable for long-duration flights.

In some examples, the wristband 102 may also include a galvanic skin response (GSR) sensor, which measures the electrical conductance of the skin, an indicator that varies with its moisture level. Since stress can cause an increase in sweating, which in turn affects skin conductance, GSR data can be a valuable indicator of stress and thus contribute to the assessment of pilot fatigue.

In some examples, a wristband 102 may incorporate a temperature sensor to monitor the pilot's skin temperature. Variations in body temperature can be indicative of changes in circadian rhythms, which are closely linked to fatigue. By tracking temperature alongside heart rate and ECG data, the system can gain a more comprehensive understanding of the pilot's physiological state.

In some examples, an accelerometer may be integrated into the wristband 102 to track movement and activity levels. Periods of inactivity or certain patterns of movement could be indicative of fatigue or drowsiness. When combined with heart rate and ECG data, movement data from the accelerometer can enhance the accuracy of fatigue detection.

In some examples, the wristband 102 may also feature a blood oxygen saturation (SpO2) sensor to measure the pilot's oxygen levels. Oxygen saturation is a parameter that can affect cognitive function and alertness. Monitoring SpO2 can provide insights into the pilot's respiratory function and overall health, which are important factors in fatigue.

In some examples, the wristband 102 may interface with the aircraft's environmental control system to receive data on cabin pressure and oxygen levels. Changes in cabin environment can influence fatigue, and incorporating this data can help in creating a more holistic fatigue assessment.

In some examples, the wristband 102 may also communicate wirelessly with the pilot's seat sensors, if available, to collect data on posture and seat pressure distribution. Poor posture or prolonged periods in a single position can contribute to physical fatigue, and this data can be used to alert the pilot to adjust their seating position or take a break.

The wearable biometric sensor (WBS) device need not be a wristband 102. A smartwatch could serve as the wearable biometric sensor (WBS) device and be equipped with various sensors capable of tracking biometric data, such as heart rate, activity levels, and sleep patterns, which can be utilized to assess fatigue levels in pilots. In some examples, a smart textile or smart garment may be used as the WBS device. These garments are embedded with sensors and conductive fibers that can measure physiological signals, including heart rate, respiration rate, and muscle activity, offering a more comprehensive set of data for fatigue assessment while potentially increasing comfort and wearability.

In some examples, a chest strap could be employed as the WBS device. Chest straps are known for their accuracy in capturing heart rate data and can also include an ECG sensor. They are often used by athletes for precise monitoring during training and could provide accurate biometric data for pilots over long flights. In some examples, an ear-worn WBS device, such as smart earbuds or an ear clip, may be used. These devices can measure heart rate, body temperature, and even blood oxygen levels through sensors placed close to the skin in the ear, where blood flow is consistent and can provide reliable data.

In some examples, a finger-worn WBS device, such as a smart ring, may be utilized as an alternative to the wristband 102. Smart rings are discreet and can continuously monitor heart rate, temperature, and HRV, providing valuable data for detecting fatigue without being obtrusive to the pilot. Similar to the wristband 102, the finger-worn WBS device would communicate with the EFB application 112 through wireless protocols to transmit the collected biometric data for analysis by the fatigue assessment engine 216.

In some examples, a head-worn WBS device, such as a smart headband or cap, may be implemented. These devices can incorporate sensors for measuring brainwave activity (EEG), which can be a direct indicator of mental fatigue and alertness levels, providing a different approach to fatigue monitoring. In some examples, a patch-type WBS device may be used, which adheres directly to the skin. These patches can monitor a variety of biometric data, including heart rate, HRV, and skin temperature, and can be designed for single-use or multiple uses, offering a discreet and non-invasive way to track pilot fatigue.

Each alternative presents a unique form factor and method for collecting biometric data, which can be tailored to the specific needs and preferences of pilots and the operational requirements of airlines. The choice of WBS device will depend on factors such as accuracy, comfort, battery life, and ease of integration with the fatigue detection system.

An electronic flight bag (EFB) 110 is a standard piece of equipment for pilots, which, in this system, is enhanced with an EFB application 112. An EFB interface 114 facilitates the interaction between the EFB application 112 and the other components of the fatigue detection system 100. The EFB application 112 displays personalized fatigue mitigation advice and serves as the primary user interface for the pilot.

For operations in low-light conditions or during night flights, an optional infrared camera 116 can be integrated into the fatigue detection system 100. This camera is capable of capturing clear facial imagery in the absence of visible light, ensuring that the system's facial recognition capabilities remain effective regardless of the lighting conditions.

A facial recognition unit 118 includes a camera 120 and facial recognition software 122. The camera 120 captures facial imagery of the pilot, which is then processed by the facial recognition software 122 to identify facial movements and eye metrics associated with fatigue, such as yawning, blink rate, and eyelid movement. The infrared camera 116 is also coupled to the facial recognition software 122.

Analytical capabilities are provided by AI model and algorithms 124, which is powered by an AI core 126. The AI model and algorithms 124 receive input from the wristband 102 via the EFB interface 114 and from the facial recognition software 122 and are responsible for analyzing the preprocessed facial imagery and biometric data to detect signs of fatigue. The AI core 126 is the computational engine that executes the machine learning model, which is trained on a comprehensive dataset with tagged facial images containing symptoms of fatigue.

Data storage 128 is managed through local storage 130, ensuring that the pilot's biometric information is kept confidential and secure. The backend infrastructure 132 comprises a Python backend 134 and a Flask API 136, which together manage the communication between the fatigue detection system 100 and the airlines database 138. The airlines database 138 stores data on the incidence of fatigue, which can be accessed through the airlines UI 140 for analysis and scheduling adjustments.

In some examples, the fatigue detection system 100 may use alternative sensors or data processing modules to accommodate different aircraft configurations or regulatory requirements. The modular design of the fatigue detection system 100 allows for such flexibility, ensuring broad applicability across various types of aircraft and airline operations.

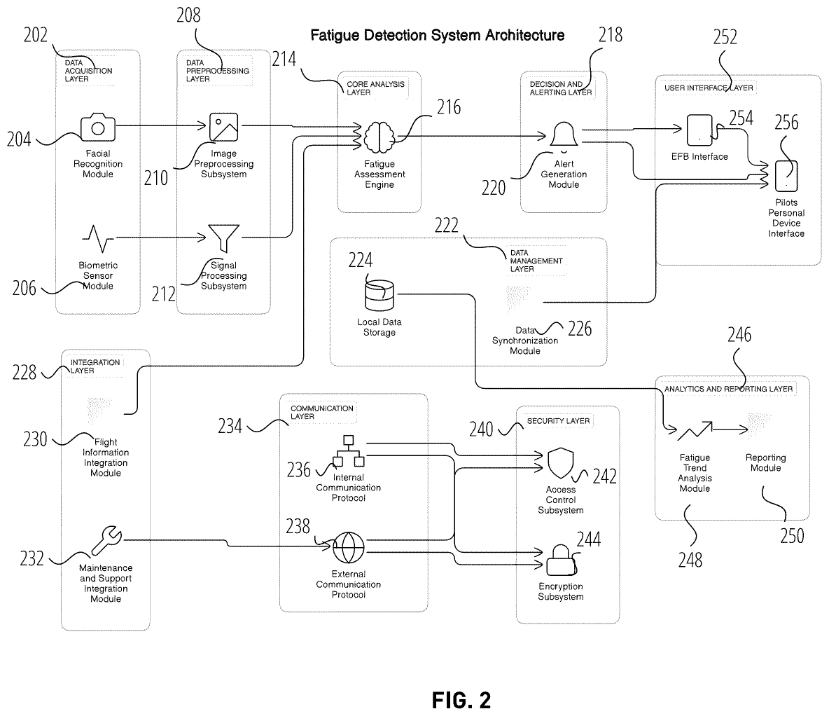

FIG. 2 is a block diagram showing a layered view of an architecture of the fatigue detection system 100, according to some examples. This diagram illustrates the hierarchical structure of the system, detailing the various layers and modules that work in concert to monitor, analyze, and respond to pilot fatigue.

A data acquisition layer 202 is the level where raw data is collected. This layer includes a facial recognition module 204 and a biometric sensor module 206. The facial recognition module 204 captures visual data related to the pilot's facial expressions and movements (e.g., using infrared camera 116 and/or camera 120), while the biometric sensor module 206 gathers physiological data from sensors embedded in wearable devices, such as heart rate and ECG sensors.

A data preprocessing layer 208 is responsible for the initial processing of the collected data to prepare it for more detailed analysis. Within this layer, an image preprocessing subsystem 210 enhances the quality of the captured facial imagery, and a signal processing subsystem 212 filters and refines the biometric data to remove noise and other artifacts that could interfere with accurate fatigue assessment.

At a core analysis layer 214, a fatigue assessment engine 216 integrates and analyzes the preprocessed data. The fatigue assessment engine 216 employs algorithms to detect signs of fatigue by identifying patterns and correlations within the data that are indicative of a fatigued state. Further details are provided below.

The decision and alerting layer 218 includes an alert generation module 220, which takes the analysis results from the fatigue assessment engine 216 and determines whether an alert should be issued to the pilot. If the pilot's fatigue level exceeds (or otherwise transgresses) a certain threshold, the alert generation module 220 activates a notification mechanism to inform the pilot.

The data management layer 222 oversees the storage and handling of data within the system. Local data storage 224 ensures that sensitive information is kept secure and accessible only to authorized systems and personnel. A data synchronization module 226 manages the flow of data between the local storage and other components, ensuring consistency and integrity.

An integration layer 228 facilitates the system's interaction with external data sources and services. A flight information integration module 230 retrieves relevant flight data from airline databases, which can be used to contextualize the fatigue assessment. For example, the flight information integration module 230 may serve as a link between the fatigue detection system 100 and the operational data that airlines maintain for each flight. The flight information integration module 230 operatively queries and retrieves data from airline databases through secure API calls or database queries. The retrieved data typically includes flight schedules, expected flight durations, time zone changes, aircraft type, and historical flight patterns.

The technical architecture of module 230 is designed to handle various data formats and communication protocols used by different airline databases. It includes a data normalization layer that standardizes the retrieved information into a consistent format that the fatigue assessment engine 216 can process. This ensures compatibility and interoperability across different airline systems.

For example, the flight information integration module 230 may pull data such as the scheduled departure and arrival times to calculate the expected duty period for the pilot. It can also access information about the flight route to determine if there are segments of the flight that require heightened alertness, such as challenging approaches or areas with heavy air traffic. Additionally, the flight information integration module 230 can consider the type of aircraft being flown, as different cockpit layouts and automation levels may influence pilot workload and fatigue.

The flight information integration module 230 also includes a data caching mechanism to reduce latency and ensure that the fatigue assessment engine 216 has timely access to the relevant flight information. This caching mechanism is designed with synchronization protocols that keep the cached data up to date with the latest changes from the airline databases.

In terms of data security, the flight information integration module 230 employs encryption and secure data transmission techniques to protect sensitive flight information during retrieval and storage. It adheres to industry-standard security practices to prevent unauthorized access and ensure data integrity.

The module's functionality extends to providing the fatigue assessment engine 216 with contextual data that can influence the generation of personalized fatigue mitigation advice. For instance, if the flight data indicates a long-haul flight with multiple time zone crossings, the advice may include strategies for managing circadian rhythm disruptions.

A maintenance and support module 232 ensures the system is kept up-to-date and functioning correctly.

A communication layer 234 encompasses both internal communication protocols 236, which govern data exchange within the system, and external communication protocols 238, which manage the transfer of information to and from external entities, such as airline databases or maintenance services.

The security layer 240 is tasked with protecting the system against unauthorized access and data breaches. An access control system 242 restricts system access to authorized users, while an encryption system 244 safeguards data in transit and at rest.

The analytics and reporting layer 246 processes the collected and analyzed data to generate insights and reports. A fatigue trend analysis module 248 examines long-term data to identify patterns and trends in pilot fatigue, while a reporting module 250 compiles this information into reports for review by airlines and other stakeholders.

In some examples, the fatigue trend analysis module 248 processes accumulated data over extended periods. The fatigue trend analysis module 248 uses data analytics techniques, including statistical analysis, machine learning algorithms, and predictive modeling, to discern underlying trends in pilot fatigue that may not be apparent from isolated incidents.

The fatigue trend analysis module 248 may aggregate and analyze various data points, such as the frequency of fatigue alerts, biometric data trends, and the correlation between fatigue incidents and specific flight segments or times of day. It may also integrate external data sources, such as pilot schedules, duty times, and rest periods, to provide a comprehensive view of factors contributing to fatigue. For example, the fatigue trend analysis module 248 may use time-series analysis to track a pilot's fatigue levels across different flights and identify whether there is an increasing trend that could indicate a need for intervention. The fatigue trend analysis module 248 may also apply cluster analysis to group similar fatigue incidents and find common characteristics among them, such as specific flight routes that consistently result in higher fatigue levels.

The reporting module 250 takes the insights generated by the fatigue trend analysis module 248 and transforms them into actionable reports. These reports are designed to be easily interpretable by airline management and safety officers, providing them with the information needed to make informed decisions about pilot scheduling, training, and overall fatigue management strategies.

The reports generated by the reporting module 250 may include visualizations such as graphs, heat maps, and charts that highlight key findings and trends. They can also be customized to focus on particular areas of interest, such as comparing fatigue levels across different pilot bases or aircraft types. The reporting module 250 may be equipped with a report generation engine that can format and export reports in various file formats, such as PDF, Excel, or web-based dashboards. This engine may be flexible, allowing for the creation of both standardized reports for regular review and ad-hoc reports for specific analyses.

Finally, the user interface layer 252 provides the means for pilots and other users to interact with the fatigue detection system 100. The EFB interface 254 serves as the primary point of interaction for pilots, displaying alerts and mitigation advice, while the pilot personal device interface 256 allows for system control and customization via personal devices such as tablets or smartphones.

In some examples, the fatigue detection system 100 may incorporate alternative or additional modules to enhance its capabilities, such as integrating with other health monitoring devices or adapting to different regulatory environments. The system's modular design allows for such flexibility, ensuring that it can be tailored to meet the specific needs of various users and operational contexts.

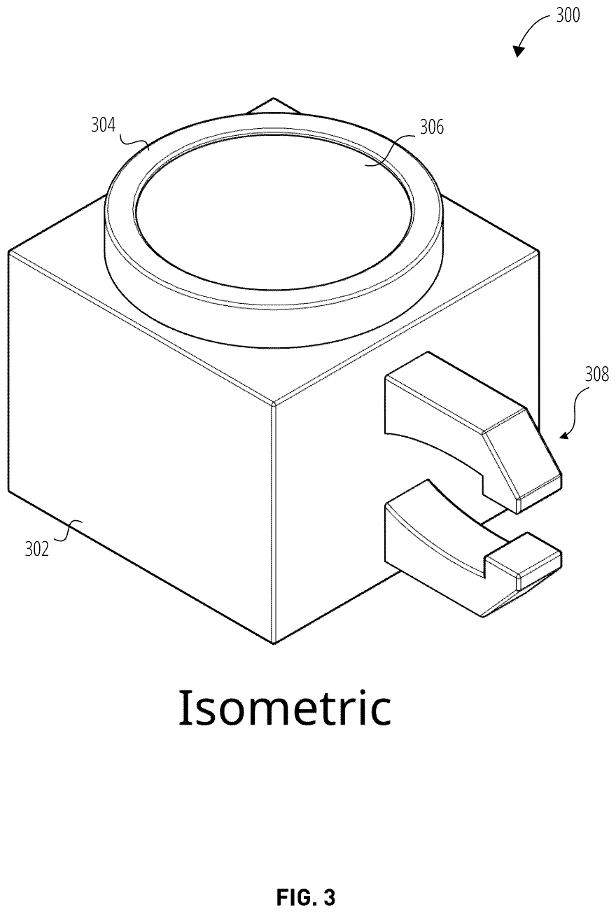

FIG. 3 is a schematic diagram showing an isometric view of a camera 300, according to some examples, which is a component of a fatigue detection system 100 designed to capture facial imagery of a pilot for fatigue assessment.

The camera 300 is housed within a camera housing 302, which provides structural support and protection for the camera's internal components. The camera housing 302 is designed to be durable and may be constructed from materials suitable for the aviation environment, ensuring that the camera 300 can operate reliably under various conditions encountered in an aircraft cockpit.

On a front surface of the camera 300 is a ring 304, which may serve multiple purposes. In some examples, the ring 304 may be a mounting ring for a lens, and/or a focusing ring that allows for manual adjustment of the camera's focus, ensuring that the facial imagery captured is sharp and clear.

A lens 306 is located within the ring 304 and may be designed with specific optical properties to enhance image quality and may include features such as anti-reflective coatings to reduce glare and improve visibility in the variable lighting conditions of the cockpit.

The camera 300 also includes a clip 308 on a side surface thereof, the clip 308 a means for attaching the camera 300 to an EFB 110 or other parts of the cockpit. The clip 308 allows for easy and secure placement of the camera 300, ensuring that it remains in the optimal position to monitor the pilot's face for signs of fatigue.

The interconnections and interfaces between the components of the camera assembly are designed to support operation and integration with the fatigue detection system 100. The camera 300 interfaces with the EFB application 112, transmitting the captured facial imagery for analysis by the fatigue assessment engine 216. The camera housing 302, ring 304, lens 306, and clip 308 all work in concert to support the camera's function, providing a robust and reliable solution for fatigue monitoring in the aviation industry.

In some examples, the camera 300 may be connected to the EFB 110 via a wired or wireless connection, allowing for the transfer of data with minimal latency. The camera 300 may also be equipped with additional sensors, such as an infrared sensor for low-light conditions, enhancing its capability to capture facial imagery in various lighting scenarios encountered during flight operations.

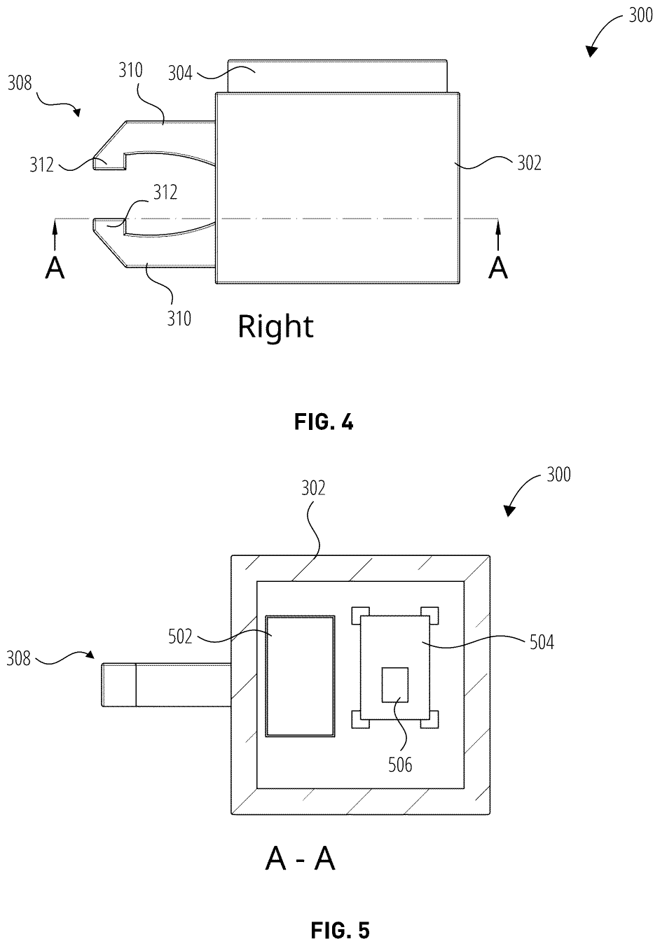

FIG. 4 is a schematic diagram showing a side view of a camera 300, according to some examples. This diagram provides a detailed perspective of the camera 300 and its associated components, which are integral to a fatigue detection system for aviation safety.

Additionally, the clip 308 is shown in relation to the camera 300 and housing 302. The clip 308 allows for the camera assembly to be affixed to various surfaces or objects within the cockpit, providing flexibility in camera placement and ensuring that the pilot's face remains within the field of view during flight operations.

In some examples, such as that illustrated in FIG. 4, the clip 308 may comprise a pair of opposed arms 310, each having an inwardly projecting finger 312 at the distal ends thereof, and define a space to accommodate an upper edge of an EFB device (e.g., a digital tablet) snuggly between them, with the projecting fingers 312 ensuring a secure and tensioned grip between the camera housing 302 and the EFB device.

In some examples, the opposed arms 310 are engineered to provide a clamping force that is strong enough to hold the camera in place during the rigors of flight, yet gentle enough to prevent damage to the EFB device. The inwardly projecting fingers 312 at the distal ends of the arms 310 enhance the stability of the connection by applying localized pressure that grips the EFB device securely.

The technical design of the clip 308 may take into account the variability in thickness and form factor of different EFB devices or other mounting locations. To accommodate this, the space between the arms 310 can be adjustable, either through a spring-loaded mechanism or a manual adjustment feature, allowing the clip to fit snugly on both thinner and thicker devices. The materials chosen for the clip, such as high-strength polymers or lightweight metals, are selected for their elasticity, durability and ability to maintain clamping force over time.

For example, the clip 308 may incorporate a silicone or rubber lining on the inner surfaces of the arms 310 and fingers 312 to increase friction and prevent slippage, while also protecting the EFB device from scratches. The design may also include a quick-release mechanism that allows the pilot to easily attach or detach the camera housing 302 without the need for tools or excessive force.

In terms of technical examples, the clip 308 may be designed with a ratchet system that allows incremental adjustments to the space between the arms 310, ensuring a custom fit for various EFB devices. Another example could be the use of magnetic elements within the clip to aid in the alignment and secure attachment to EFB devices that have compatible metallic components.

The clip 308's design is also mindful of the cockpit environment, where space is at a premium and ease of use is critical. The clip 308 allows for quick installation and removal, which is helpful for pilots who may need to transition between different phases of flight or use the EFB device for other tasks.

In some examples, the camera 300 may include additional features such as image stabilization, automatic exposure control, and real-time video streaming capabilities, which enhance its performance in the dynamic and demanding context of aviation. The camera 300 may also be designed to comply with aviation industry standards for electronic devices, ensuring reliability and safety in its application as part of a pilot fatigue detection system.

FIG. 4 also shows a cross-section line for the cross-sectional view of FIG. 5.

FIG. 5 is a schematic diagram showing a cross-sectional view of camera 300 according to some examples. This diagram provides an in-depth look at the internal structure and components of a camera 300 designed for use in a fatigue detection system for pilots.

The battery 502 is a component that powers the camera 300. The battery 502 is selected for its capacity to sustain camera functions over extended periods, for example during long-haul flights where continuous monitoring of the pilot's biometric data is required.

Positioned within the camera 300 is the board 504, which serves as the central circuitry hub. The board 504 houses the processing unit, memory, and other electronic components that enable the collection, processing, and storage of image data (e.g., video or still image data). The board 504 is engineered to handle the computational demands of real-time data analysis and to interface seamlessly with other components of the fatigue detection system 100.

The Bluetooth chip 506 is integrated into the board 504 and facilitates wireless communication between the camera 300 and the electronic flight bag (EFB) application or other devices within the fatigue detection system 100. The Bluetooth chip 506 is chosen for its low energy consumption and robust connectivity, ensuring that image data can be transmitted securely and without interruption.

The interconnections between the battery 502, board 504, and Bluetooth chip 506 ensure efficient power management, reliable data processing, and communication. The battery 502 supplies power to the board 504, which in turn controls the operation of the Bluetooth chip 506, orchestrating the flow of data between the camera 300 and the EFB application 112.

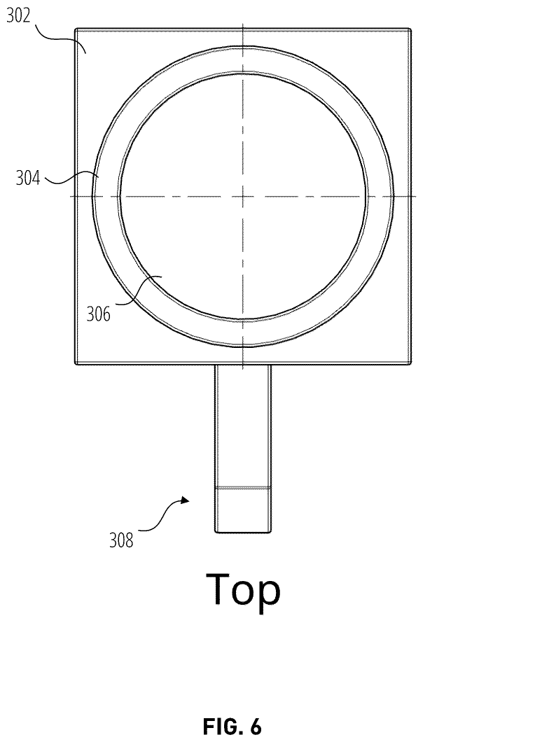

FIG. 6 is a schematic diagram showing a top view of a camera assembly, according to some examples. This diagram provides a detailed overview of the camera assembly's external features and their spatial configuration.

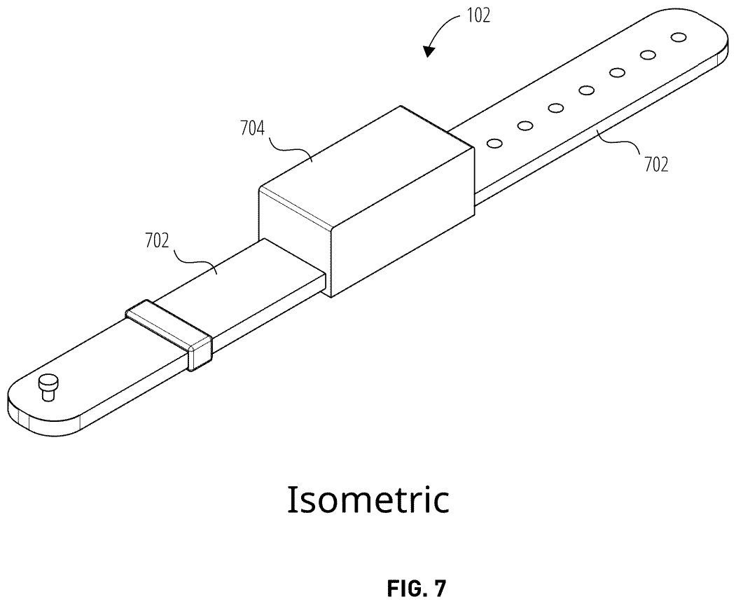

FIG. 7 is a schematic diagram showing an isometric view of a wristband 102, according to some examples. This diagram provides a comprehensive depiction of the wristband's external and visible features, which are for the operation of a fatigue detection system designed for aviation applications.

The wristband 102, as shown in FIG. 7, is comprised of several components that work in unison to monitor and analyze a pilot's biometric data for signs of fatigue.

As noted above, the wristband 102 operates as a wearable biometric sensor (WBS), and includes a heart rate monitor and ECG sensors for collecting heart rate and heart rate variability (HRV) data. These sensors are not shown in FIG. 7 but are understood to be integrated within the wristband's structure. The data collected by the WBS is for determining the pilot's level of fatigue.

The wristband 102 also includes a haptic feedback mechanism, which is responsible for providing an alert to the pilot based on the fatigue level exceeding (or otherwise transgressing) a predetermined threshold. This alert maybe delivered in the form of vibrations, which are designed to be noticeable yet non-intrusive, ensuring that the pilot can be made aware of potential fatigue without causing undue distraction.

In some examples, the wristband 102 may interface with an EFB application 112, which displays personalized fatigue mitigation advice based on the analyzed biometric data. The EFB application 112 serves as the user interface for the pilot, presenting actionable recommendations to mitigate fatigue, such as taking a controlled rest, consuming caffeine, or engaging in physical activity.

The interconnections between the wristband 102 and EFB application 112 may be facilitated by a communication module, for example incorporating a Bluetooth chip for wireless data transmission. This module ensures that biometric data can be securely and efficiently transmitted from the wristband 102 to the EFB application for real-time analysis and feedback.

The design of the wristband 102 in FIG. 7 may also consider ergonomic factors to ensure comfort and ease of use for the pilot. The materials used for the wristband's exterior are selected for their durability and skin-friendly properties, allowing the pilot to wear the wristband for extended periods without discomfort.

In some examples, the wristband's design may be adapted to meet various regulatory requirements for wearable technology in the aviation industry, focusing on safety, reliability, and pilot comfort. The isometric view provided by FIG. 7 offers a clear understanding of the wristband's design and functionality, facilitating the development and maintenance of the device as part of a fatigue detection system aimed at enhancing aviation safety.

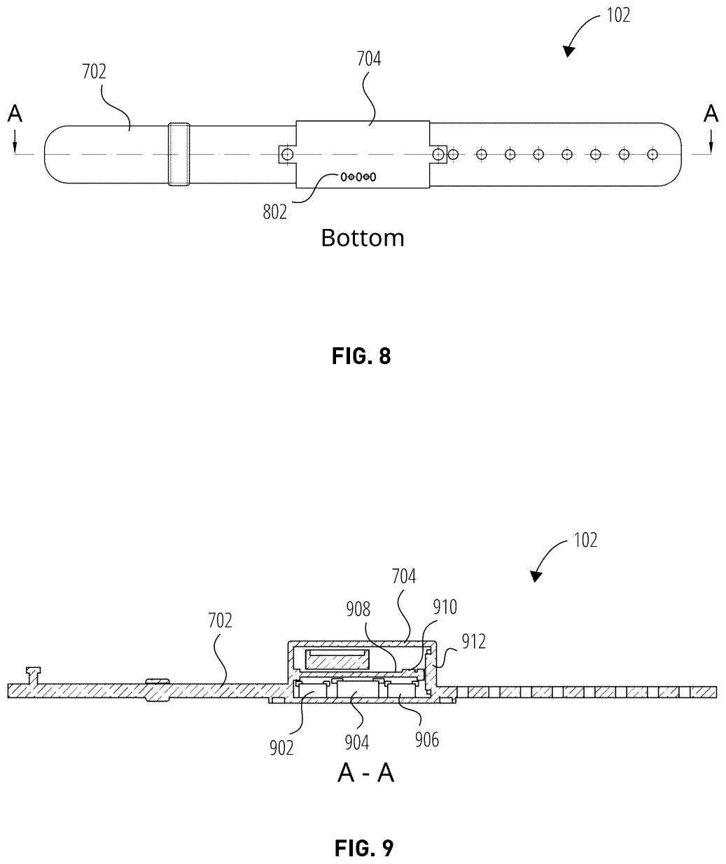

FIG. 8 is a top view of the wristband 102, according to some examples. This view provides a detailed perspective of the wristband's design and its functional components, which are integral to the operation of the fatigue detection system.

The wristband 102, as depicted in FIG. 8, features a strap 702 that is designed to wrap comfortably around the pilot's wrist. The strap 702 is equipped with multiple adjustment holes, which serve to accommodate wrists of varying sizes, ensuring a secure and customizable fit for different users. The presence of multiple holes allows for fine-tuning of the wristband's tightness, providing flexibility and comfort during extended periods of wear.

A clasp, located at the end of the strap 702, is a mechanism that securely fastens the wristband 102 around the pilot's wrist. The clasp is designed to be easy to engage and disengage, allowing for quick donning and removal of the wristband without sacrificing the security of the fi

Central to the wristband 102 is the sensor box 704, which houses the electronic components for fatigue detection. This sensor box 704 contains sensors such as the ECG sensor and the heart rate monitor. These sensors are responsible for collecting the biometric data that is analyzed to assess the pilot's level of fatigue.

The sensor box 704 further includes a number of holes 802 that enable sensor detection. These holes 802 are located to allow the sensors housed within the sensor box 704 to interact with the external environment and the pilot's skin, thereby collecting the relevant biometric data for fatigue assessment.

example features and functions of the holes 802 in the sensor box 704 include:
Sensor Exposure: The holes 802 provide an opening through which the sensors, such as the ECG sensor 902 and the heartrate sensor 904 can make direct contact with the pilot's skin or receive environmental input for accurate data collection.
Data Accuracy: By allowing sensors to be exposed to the skin and environment, the holes 802 help to reduce signal interference and improve the precision of the biometric readings.
Ventilation: The holes 802 also facilitate airflow within the sensor box 704, which can help to regulate temperature and prevent moisture buildup.
Comfort and Wearability: The presence of holes 802 can contribute to the overall comfort of the wristband 102 by making it lighter and allowing the skin to breathe, which is particularly beneficial during long flights.

FIG. 9 is a section view taken along the line A-A in FIG. 8, showing the internal structure of a wristband 102, according to some examples. This diagram provides an in-depth look at the internal components of the wristband 102, which is a part of the fatigue detection system 100 designed for pilots.

The sensor box 704 serves as a housing for the wristband's electronic components. Within this enclosure, the board 908 acts as the primary circuit board, orchestrating the functionality of the various sensors and modules. Attached to the board 908 are multiple sensors and a communication module for the operation of the wristband 102.

The ECG sensor 902 is one of the components coupled to the board 908. It is responsible for capturing the electrocardiogram data, which is used for measuring heart rate variability (HRV), a physiological indicator of fatigue. The heart rate sensor 904 complements the ECG sensor 902 by monitoring the pilot's heart rate, providing an additional metric for fatigue assessment.

In some examples, the wristband 102 may include a second ECG sensor 906, which works in conjunction with the first ECG sensor 902 to enhance the accuracy and reliability of the ECG data collected. This redundancy may be particularly beneficial in dynamic environments where consistent data quality is critical.

The Bluetooth module 910, also integrated into the board 908, facilitates wireless communication between the wristband 102 and the EFB application 112. This module ensures that the biometric data collected by the wristband's sensors can be transmitted securely and efficiently to the fatigue detection system for analysis.

In some examples, the wireless communication between the wristband 102 and the EFB application 112 may be facilitated by a Wi-Fi module instead of the Bluetooth module 910. This alternative module may allow for data transmission over local Wi-Fi networks, which may offer higher data transfer rates and potentially greater range than Bluetooth, depending on the cockpit environment and the specific Wi-Fi technology used.

In some examples, the wristband 102 could utilize Near Field Communication (NFC) technology for pairing and data transfer with the EFB application 112. NFC may enable a simple tap-to-connect functionality, which could streamline the process of establishing a connection between the wristband and the EFB device, particularly in situations where quick setup is advantageous.

In some examples, the wristband 102 may incorporate a cellular module to provide an alternative communication channel. This module would allow the wristband to transmit data directly to the fatigue detection system via cellular networks, bypassing the need for local wireless connectivity. This could be particularly useful in scenarios where the EFB application 112 is not readily accessible or when data needs to be sent to a centralized location for analysis.

In some examples, the wristband 102 may be equipped with a proprietary wireless communication protocol that is specifically designed for secure and reliable data transmission in aviation environments. This proprietary protocol may offer advantages in terms of security features tailored to the sensitive nature of biometric data and compliance with aviation industry standards.

In some examples, the wristband 102 may include multiple communication modules, allowing it to switch between Bluetooth, Wi-Fi, NFC, cellular, or proprietary protocols based on the best available connection. This multi-modal communication capability may enhance the wristband's versatility and ensure consistent data transmission under various conditions and in different operational contexts.

The vibration motor 912, housed within the sensor box 704, is an alerting component of the wristband 102. When the fatigue detection system 100 identifies a fatigue level that exceeds the predetermined threshold, the vibration motor 912 is activated. This activation triggers a haptic alert in the form of a vibration, which is delivered directly to the pilot's wrist. The intensity and pattern of this vibration are designed to be noticeable yet non-intrusive, ensuring that the pilot is made aware of potential fatigue without causing undue distraction.

The interconnections between the board 908, the sensors 902 and 904, the additional ECG sensor 906, the Bluetooth module 910, and the vibration motor 912 provide efficient power management, reliable data processing, and seamless communication within the wristband 102.

In some examples, the wristband 102 may incorporate alternative or additional sensors to accommodate different pilot needs or regulatory requirements. The modular design of the wristband 102 allows for such flexibility, ensuring that it can be tailored to meet the specific needs of various users and operational contexts.

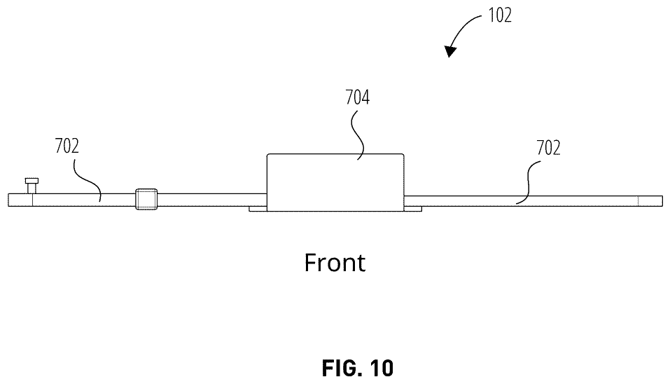

FIG. 10 is a sideview of the wristband 102, according to some examples, showcasing the design and layout of the wristband 102. This view emphasizes the external features of the wristband 102, such as the strap 702 and the sensor box 704, which are visible from this perspective.

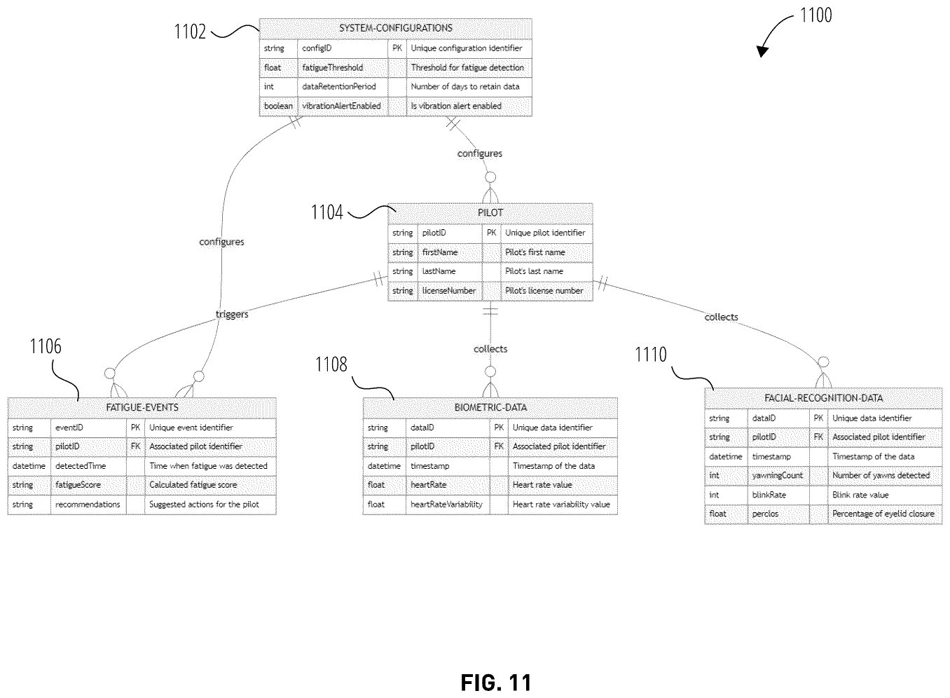

### FIG. 11—Entity-Relationship Diagram for Fatigue Detection Technology

FIG. 11 is a data architecture diagram illustrating a data architecture 1100 of data entities used to support the operations of a fatigue detection system 100, according to some examples.

The system configuration table 1102 serves as a repository for system settings and configurations. It includes attributes such as configID, fatigueThreshold, dataRetentionPeriod, and vibrationAlertEnabled. The configID serves as a primary key, uniquely identifying each configuration record. The fatigueThreshold attribute represents the level at which fatigue is determined to be significant enough to warrant an alert. The dataRetentionPeriod specifies the duration for which data will be retained in the fatigue detection system 100, and the vibrationAlertEnabled attribute indicates whether the haptic feedback mechanism is active.

The pilot table 1104 contains pilot-specific information, including attributes such as pilotID, firstName, lastName, and licenseNumber. The pilotID is the primary key for this table, ensuring that each record pertains to a unique individual. The firstName and lastName attributes store the pilot's name, while the licenseNumber holds the pilot's official aviation license number.

The fatigue events table 1106 logs instances of detected fatigue, with attributes including eventID, pilotID, detectedTime, fatigueScore, and recommendations. The eventID is a primary key that uniquely identifies each fatigue event. The pilotID serves as a foreign key linking to the pilot table 1104, associating each fatigue event with the corresponding pilot. The detectedTime attribute records the time when fatigue was detected, the fatigueScore quantifies the level of fatigue, and the recommendations attribute stores suggested actions for the pilot to mitigate fatigue.

The biometric data table 1108 captures physiological data from the wearable biometric sensors, with attributes such as dataID, pilotID, timestamp, heartRate, and heartRateVariability. The dataID is the primary key, uniquely identifying each set of biometric data. The pilotID, as a foreign key, links to the pilot table 1104, associating the biometric data with the specific pilot. The timestamp records the time at which the data was collected, while the heartRate and heartRate Variability attributes store the respective biometric measurements.

The facial recognition data table 1110 stores data related to the facial recognition process, with attributes including dataID, pilotID, timestamp, yawningCount, blinkRate, and perclos. The dataID is the primary key for this table, and the pilotID, as a foreign key, references the pilot table 1104. The timestamp attribute indicates when the facial recognition data was collected. The yawningCount, blinkRate, and perclos attributes store metrics related to the pilot's facial expressions and eye movements, which are for assessing fatigue.

The data architecture integrates with other system components, such as the fatigue assessment engine 216 and the user interface layer 252, by providing the relevant data inputs for fatigue detection and the presentation of information to the pilot. The relationships between the tables facilitate the system's ability to correlate different data types, such as biometric and facial recognition data, to provide a comprehensive assessment of the pilot's fatigue state.

In some examples, alternative configurations of the data architecture may include additional tables or attributes to capture more detailed information or to comply with specific regulatory requirements. The system may also include mechanisms for anonymizing data to protect pilot privacy, as indicated in the pilot table 1104, where pilots may opt out of releasing certain information for model training purposes.

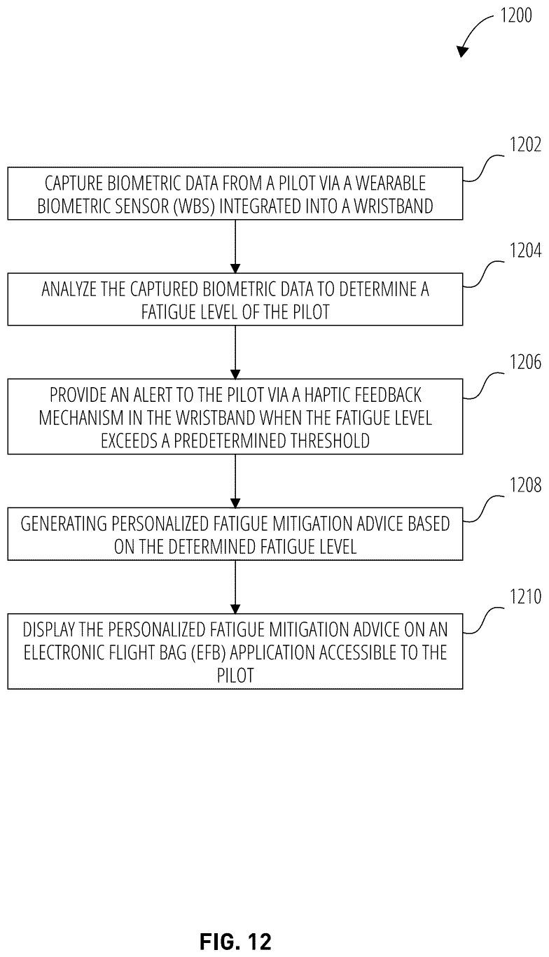

FIG. 12 is a flowchart illustrating a method 1200 of detecting and responding to pilot fatigue, according to some examples, of a fatigue detection system. Although the example method 1200 depicts a particular sequence of operations, the sequence may be altered without departing from the scope of the present disclosure. For example, some of the operations depicted may be performed in parallel or in a different sequence that does not materially affect the function of the method 1200. In some examples, different components of an example device or system that implements the method 1200 may perform functions at substantially the same time or in a specific sequence.

At block 1202, method 1200 captures biometric data from a pilot via a wearable biometric sensor (WBS) integrated into or comprising a wristband 102. The WBS, which includes one or more ECG sensors 104 and a heart rate sensor 106, collects data such as heart rate variability (HRV) and electrocardiogram (ECG) signals, which are indicators of the pilot's physiological state and potential fatigue.

In some examples, at block 1202, the wristband 102 is equipped with sensor technology designed to accurately measure and record the electrical activity generated by the heart muscle. The ECG sensor, which may consist of multiple electrodes, contacts the skin's surface and detects electrical changes on the skin that arise from the heart muscle's electrophysiologic pattern of depolarizing and repolarizing during each heartbeat. This data is for identifying cardiac anomalies that could indicate excessive stress or fatigue.

The heart rate sensor 106, for example utilizing photoplethysmography (PPG) technology, emits light into the skin and measures the light absorption changes caused by blood flow. This optical measurement allows the wristband 102 to determine the time interval between heartbeats, known as the RR interval, from which HRV is derived. HRV is a marker of the autonomic nervous system's activity, reflecting the body's ability to respond to varying demands and stress levels, which can be directly correlated to fatigue.

In some examples, the wristband 102 may perform continuous monitoring of the pilot's biometric data, capturing high-resolution ECG waveforms and HRV metrics. The ECG sensor 902 or heartrate sensor 904 may employ a high sampling rate, for example, 1300 Hz, to ensure that the captured data is of sufficient granularity to detect even subtle changes in the ECG signal that may indicate the onset of fatigue. The heart rate sensor, on the other hand, may use a green LED light source with a complementary optical sensor tuned to detect the optimal wavelength for accurate pulse detection.

The wristband 102 may also include a microcontroller unit (MCU) with signal processing capabilities to filter and preprocess the raw sensor data. This preprocessing may involve the application of digital filters, such as band-pass filters, to remove noise and artifacts from the ECG signal, or the implementation of algorithms to detect and correct for motion-induced artifacts in the PPG signal. The processed data is then transmitted wirelessly, for example using a low-energy Bluetooth connection, to a paired device, such as the EFB application, for further analysis.

Additionally, the wristband 102 may incorporate temperature sensors, accelerometers, or gyroscopes to provide contextual data that can enhance the assessment of the pilot's condition. For example, an accelerometer could detect changes in physical activity levels, while a temperature sensor could provide insights into the pilot's thermal stress, both of which are relevant to fatigue analysis.

The integration of these sensors into a single wristband 102 worn on the wrist allows for a non-invasive, continuous, and real-time monitoring solution that is both convenient and effective for pilots during flight operations. The data collected by the wristband 102 is input for the fatigue assessment engine 216, enabling it to generate accurate and personalized fatigue mitigation advice based on the pilot's current physiological state.

At block 1204, method 1200 analyzes the captured biometric data to determine a fatigue level of the pilot. This analysis is performed by a fatigue assessment engine 216, which processes the HRV and ECG data to assess the pilot's current state. The fatigue assessment engine 216 may use a machine learning model (e.g., AI model and algorithms 124) trained on a dataset with tagged facial images containing symptoms of fatigue to enhance the accuracy of the fatigue level determination.

In some examples, at block 1204, the fatigue assessment engine 216 employs algorithms and computational techniques to interpret the biometric data. The HRV data, which reflects the time variation between consecutive heartbeats, is analyzed using time-domain, frequency-domain, and non-linear methods to extract features that indicate the autonomic nervous system's balance. For instance, time-domain measures such as the standard deviation of the NN intervals (SDNN) and the root mean square of successive differences (RMSSD) are calculated to provide insights into the pilot's stress and fatigue levels.

The ECG data, comprising the PQRST complex waveforms for example, may be subjected to signal processing to detect anomalies such as arrhythmias or variations in the QRS complex that may be indicative of physiological stress or fatigue. The fatigue assessment engine 216 may apply wavelet transforms to decompose the ECG signal into its constituent frequencies, enabling the detection of transient features that could be missed by traditional Fourier analysis.

The machine learning model (e.g., AI model and algorithms 124) within the fatigue assessment engine 216 may be a Convolutional Neural Network (CNN) or a Recurrent Neural Network (RNN), and trained on a dataset that includes both physiological signals and facial imagery tagged with fatigue symptoms. The training process involves exposing the model to a wide range of data scenarios, from well-rested to severely fatigued states, allowing the model to learn the complex patterns associated with fatigue.

During the training phase, the model's parameters may be optimized using techniques such as backpropagation and gradient descent to minimize the error between the predicted fatigue levels and the actual levels indicated by the training data. The model's performance may be validated using a separate dataset to ensure that it generalizes well to new, unseen data.

In some examples, the fatigue assessment engine 216 integrates the outputs from the HRV and ECG analysis with the inferences made by the machine learning model to arrive at a comprehensive assessment of the pilot's fatigue level. This integrated approach leverages both physiological signals and visual cues to enhance the reliability of the fatigue determination.

The fatigue assessment engine 216 may also incorporate threshold-based mechanisms, where certain HRV or ECG metrics must exceed predefined values to trigger a fatigue alert. For example, if the RMSSD value falls below a certain threshold, it may indicate reduced parasympathetic activity, which is often associated with increased fatigue.

At block 1206, method 1200 provides an alert to the pilot via a haptic feedback mechanism (e.g., vibration motor 912) in the wristband 102 when the fatigue level exceeds a predetermined threshold. The haptic feedback mechanism, which may vary the intensity and pattern of vibrations based on the severity of the detected fatigue level, serves as a non-disruptive notification to the pilot.

In some examples, at block 1206, the haptic feedback mechanism delivers tactile stimulation in the form of vibrations directly to the pilot's skin, ensuring that the alert is both felt and acknowledged even in a noisy cockpit environment where auditory cues may be missed. The haptic feedback mechanism can be composed of one or more actuators, such as eccentric rotating mass (ERM) motors or linear resonant actuators (LRAs), which are controlled by the microcontroller unit (MCU) of the wristband 102. The MCU receives the fatigue level data from the fatigue assessment engine and activates the haptic mechanism accordingly.

To provide a nuanced alert system, the intensity of the vibrations can be modulated to correspond with the severity of the detected fatigue level. For example, a mild fatigue level may trigger a low-intensity, gentle vibration pattern, while a more severe fatigue level may result in a stronger, more urgent vibration pattern. This gradation of haptic feedback allows the pilot to gauge the urgency of the alert and take appropriate action.

The pattern of vibrations, or haptic signature, may also be varied to convey different messages. For instance, a continuous vibration could indicate a recommendation to take a mental break, while a pulsating vibration pattern could suggest the need for physical activity or caffeine intake. These haptic signatures are designed to be intuitive and easily distinguishable, minimizing the cognitive load on the pilot during interpretation.

In addition to varying intensity and pattern, the haptic feedback mechanism may also incorporate a temporal aspect, where the duration of the vibration alert is adjusted based on the pilot's response. If the pilot does not acknowledge the initial alert, the wristband 102 may escalate the notification by increasing the duration or changing the vibration pattern to ensure that the alert is not overlooked.

The haptic feedback mechanism's integration into the wristband 102 allows for a method of fatigue notification that does not rely on the pilot's visual or auditory attention, which may already be heavily taxed during flight operations. This method of alerting is advantageous in maintaining the pilot's focus on flying the aircraft while still being informed about their fatigue status.

At block 1208, method 1200 generates personalized fatigue mitigation advice based on the current flight conditions and type of fatigue. This advice is tailored to the pilot's specific situation and may include recommendations such as taking a controlled rest, consuming caffeine, or engaging in physical activity. The personalized advice is generated by considering various factors, including the type of fatigue detected, the pilot's biometric data, and the flight information from the airline's route database.

In some examples, at block 1208, the generation of personalized fatigue mitigation advice may involve a complex decision-making process that takes into account a comprehensive view of the pilot's condition and the operational context of the flight. The system's fatigue assessment engine 216, which may include a decision-making algorithm, processes the facial and biometric data, such as HRV and ECG, to classify the type of fatigue experienced by the pilot-whether it is active, passive, or chronic fatigue.

The algorithm considers passive fatigue, which is often caused by a lack of quality sleep, extended work hours, or low mental load. In such cases, the advice may prioritize strategies for immediate alertness, such as taking a controlled rest during autopilot phases or consuming caffeine to temporarily boost cognitive function.

For active fatigue, which results from prolonged periods of stress or a high mental load, the advice may focus on stress relief strategies, such as performing breathing exercises or taking breaks from current duties.

Chronic fatigue, which can be indicative of ongoing lifestyle or health issues, may trigger the system to recommend a medical evaluation or lifestyle changes in addition to in-flight mitigation strategies.

The personalized advice also takes into account the pilot's current biometric data, which provides real-time insights into their physiological state. For example, if the biometric data indicates elevated stress levels, the advice may include relaxation techniques or breathing exercises to reduce stress.

Furthermore, the fatigue detection system 100 integrates flight information from the airline's route database to ensure that the advice is operationally feasible. The system considers factors such as flight duration, time of day, and the specific duties of the pilot during different flight phases. For instance, during flight operations such as takeoff and landing, the fatigue detection system 100 may not recommend a controlled rest but might suggest other mitigation strategies that can be safely implemented. The personalized fatigue mitigation advice is dynamically generated and may be updated in real-time as the pilot's fatigue level and biometric data change throughout the flight. The system's user interface (UI) presents the advice in an accessible and actionable format, allowing the pilot to easily understand and act upon the recommendations.

At block 1210, method 1200 displays the personalized fatigue mitigation advice on an EFB application 112 accessible to the pilot. The EFB application 112 serves as the interface through which the pilot receives the advice, and it may present options for the pilot to mitigate fatigue during phases of flight, taking into account the feasibility of the advice given the flight's duration and specific pilot duties.

The sequence and decision-making process of method 1200 involve a continuous loop of data capture, analysis, and response, with the fatigue detection system 100 dynamically adjusting its operations based on real-time data and the pilot's interaction with the EFB application. The system's design allows for the integration of additional sensors or data sources, and the method 1200 may be adapted to accommodate different aircraft configurations or regulatory environments. In some examples, the system may also include features to ensure data privacy and security, such as anonymizing data or employing encryption protocols for data transmission.

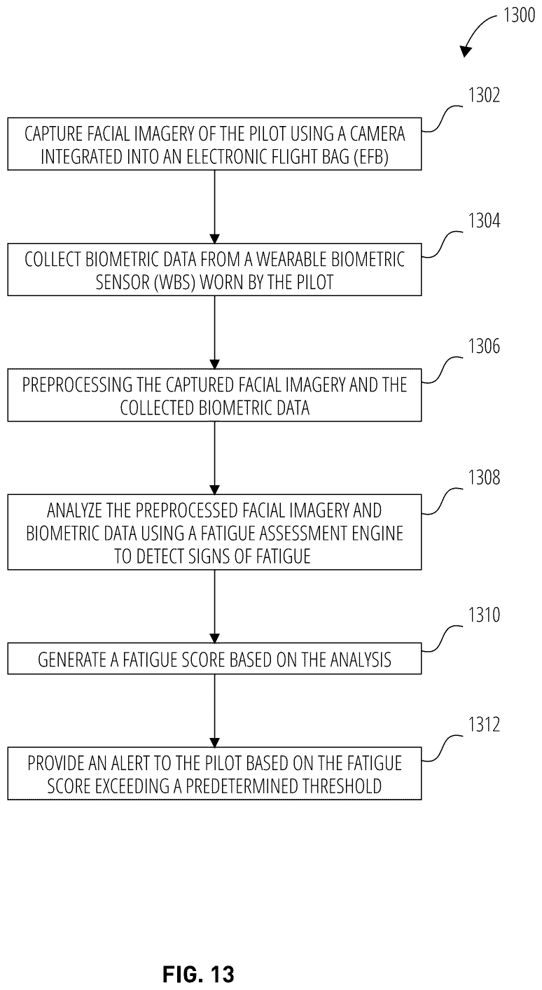

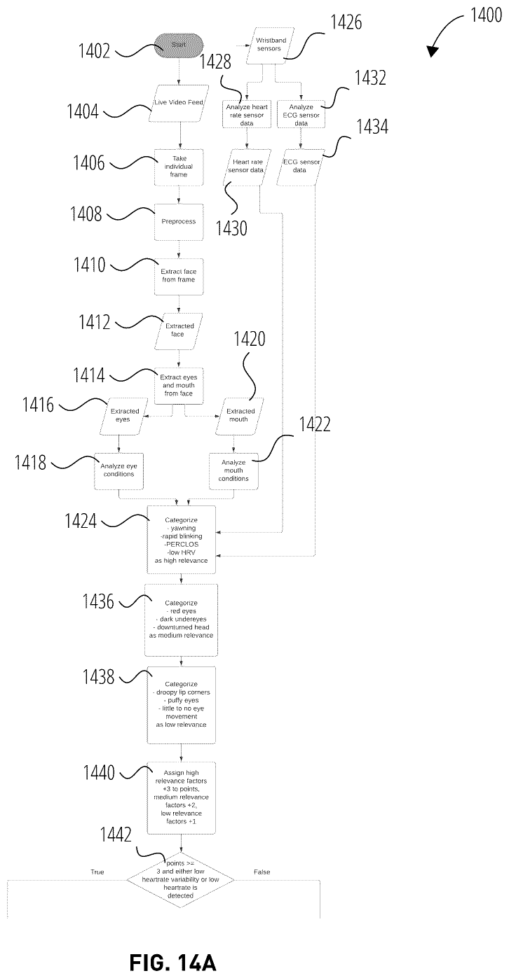

FIG. 13 is a flowchart illustrating a method 1300 of fatigue detection and alerting, according to some examples, of a fatigue detection system 100 specifically designed for aviation safety. Although the example method 1300 depicts a particular sequence of operations, the sequence may be altered without departing from the scope of the present disclosure. For example, some of the operations depicted may be performed in parallel or in a different sequence that does not materially affect the function of the method 1300. In some examples, different components of an example device or system that implements the method 1300 may perform functions at substantially the same time or in a specific sequence. This flexibility allows the fatigue detection system to adapt to various operational scenarios and pilot preferences, ensuring a robust and responsive approach to managing pilot fatigue.

At block 1302, method 1300 captures facial imagery of the pilot using a camera 300 integrated into or coupled to an electronic flight bag (EFB 110). This camera, which may be a standard or infrared camera for low-light conditions (or a combination of these two camera types), continuously monitors the pilot's facial expressions and movements, indicators of fatigue such as yawning frequency, blink rate, and eyelid closure percentage (PERCLOS).

At block 1304, method 1300 collects biometric data from a wearable biometric sensor (WBS) (e.g., a wristband 102) worn by the pilot. The WBS, which may include a heart rate monitor and ECG sensors, gathers physiological data that reflects the pilot's physical state, such as heart rate and heart rate variability (HRV), both of which are important biomarkers for assessing fatigue levels.

At block 1306, method 1300 preprocesses the captured facial imagery and the collected biometric data. The preprocessing involves enhancing the image quality to facilitate accurate facial recognition and filtering noise from the heart rate and HRV data. This operation is for ensuring that the subsequent analysis is based on high-quality and reliable information.

At block 1308, method 1300 analyzes the preprocessed facial imagery and biometric data using a fatigue assessment engine 216 to detect signs of fatigue. The fatigue assessment engine 216 employs a convolutional neural network (CNN) based facial recognition system and a machine learning model trained on a comprehensive dataset with tagged facial images containing symptoms of fatigue. The fatigue assessment engine 216 assigns points to different signs of fatigue based on their relevance, and a fatigue event is logged when the sum of points exceeds a specific threshold.

At block 1310, method 1300 generates a fatigue score based on the analysis. A scoring subsystem of the fatigue assessment engine 216 operates on a threshold basis, where the cumulative points from the detected signs of fatigue are used to assess the level of fatigue. If the score exceeds a specified threshold, indicating that the pilot is fatigued, the system recognizes that immediate action is required.

At block 1312, method 1300 provides an alert to the pilot based on the fatigue score exceeding a predetermined threshold. The alert may include a tactile alert via the WBS, which vibrates gently to notify the pilot without causing alarm or distraction. The fatigue detection system 100 may also display a message on the EFB application 112 with instructions for the pilot to mitigate fatigue, such as having a coffee or snack, taking a walk around the cabin, or taking a controlled rest, depending on the flight conditions and available time.

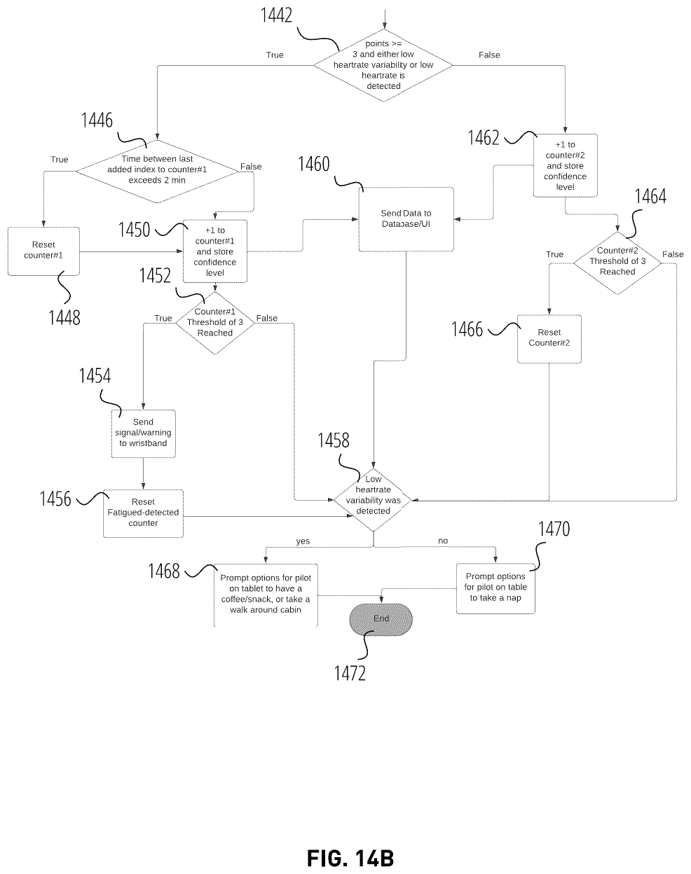

FIG. 14A and FIG. 14B are flowcharts illustrating a method 1400 of fatigue detection and response, according to some examples, of a fatigue detection system 100 for pilots. Although the example method 1400 depicts a particular sequence of operations, the sequence may be altered without departing from the scope of the present disclosure. For example, some of the operations depicted may be performed in parallel or in a different sequence that does not materially affect the function of the method 1400. In some examples, different components of an example device or system that implements the method 1400 may perform functions at substantially the same time or in a specific sequence.

At block 1402, method 1400 begins the fatigue detection process. At block 1428, the method 1400 captures and analyzes heart rate sensor data, and at block 1432, captures and analyzes ECG sensor data from the wristband 102. This biometric data is used for assessing the physiological state of the pilot.

At block 1404, the method captures a live video feed from the camera integrated into the EFB 110. At block 1406, an individual frame is taken from the live video feed, and at block 1408, the method preprocesses the frame and extracts the pilot's face (block 1410-block 1412).

At block 1414, block 1416 and block 1420, method 1400 extracts the eyes and mouth from the face, as these features are indicators of fatigue. At block 1418, the method analyzes eye conditions, and at block 1422, it analyzes mouth conditions. The extracted eyes and mouth are used to detect signs such as yawning, rapid blinking, and other facial movements associated with fatigue.

At block 1424, method 1400 categorizes the detected signs of fatigue based on their relevance to fatigue assessment. High relevance factors, such as yawning and rapid blinking, are assigned more points, as indicated at block 1424. Medium relevance factors, such as red eyes and dark areas under the eyes, are assigned fewer points, as indicated at block 1436. Low relevance factors, such as droopy lip corners and little to no eye movement, are assigned the fewest points, as indicated at block 1438.

At block 1440, method 1400 assigns points based on the level of relevance of the factors. For example, high relevance=3 points, medium relevance=2 points, and low relevance=1 point.

At decision block 1442, method 1400 evaluates whether the points total transgresses a threshold and if low heart rate variability or low heart rate is detected. If true, the method proceeds to decision block 1446, where it determines if the time between the last added index to counter#1 exceeds 2 minutes. If false, the method 1400 proceeds to block 1462 where +1 is added to counter#2 and the confidence level is stored. From block 1450 or block 1462, the relevant data is sent to a data storage 128 or user interface layer 252. From block 1462, at decision block 1464, a determination is made if counter#2 has reached or transgressed a threshold (e.g., of 3). If so, at block 1466, counter#2 is reset. On the other hand, if not, the method proceeds to decision block 1458 (see below).

At decision block 1446, if the time exceeds 2 minutes at decision block 1446, the method resets counter#1 at block 1448 and the method proceeds to block 1450. If the time does not exceed 2 minutes at decision block 1446, +1 is added to counter#1 and the confidence level is stored at block 1450.

At decision block 1452, method 1400 checks if the threshold of 3 for counter#1 is reached. If true, the method sends a signal/warning to the wristband at block 1454 and resets the fatigued-detected counter at block 1456. If false or after block 1456, a determination is made a decision block 1458 if low heart rate variability was detected. If yes, then at block 1468, method 1400 prompts options for the pilot to mitigate fatigue (e.g., have a coffee or snack., or walk around the cabin) if low heart rate variability was detected. If no, at block 1470, if no low heart rate variability was detected, the method prompts options for the pilot to take a nap. At block 1472, the method ends the fatigue detection cycle.

At decision block 1458, method 1400 checks if 2 minutes have elapsed since the last alert. If true, the method resets counter#1 at block 1460. If not, the method continues to monitor for signs of fatigue.

At block 1462, method 1400 adds to counter#2 and stores the confidence level. At decision block 1464, the method checks if the threshold of 3 for counter#2 is reached. If true, the method prompts options for the pilot on the tablet to have a coffee/snack or take a walk around the cabin at block 1468. If false, the method resets counter#2 at block 1466.

The sequence and decision-making process of method 1400 involve a continuous loop of data capture, analysis, and response, with the system dynamically adjusting its operations based on real-time data and the pilot's interaction with the EFB application. The system's design allows for the integration of additional sensors or data sources, and the method may be adapted to accommodate different aircraft configurations or regulatory environments. In some examples, the system may also include features to ensure data privacy and security, such as anonymizing data or employing encryption protocols for data transmission.

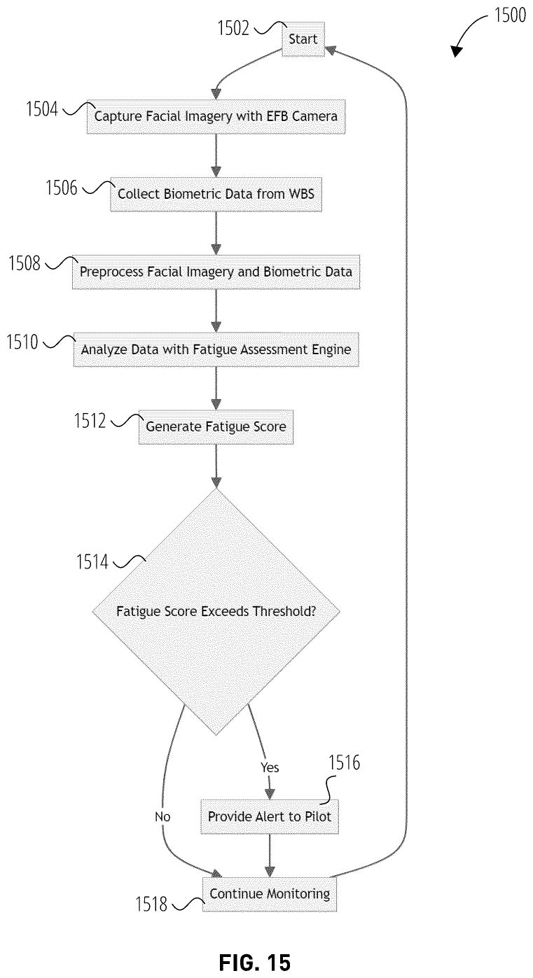

FIG. 15 is a flowchart illustrating a method 1500 of fatigue detection and alerting, according to some examples, of a fatigue detection system for aviation safety. Although the example method 1500 depicts a particular sequence of operations, the sequence may be altered without departing from the scope of the present disclosure. For example, some of the operations depicted may be performed in parallel or in a different sequence that does not materially affect the function of the method 1500. In some examples, different components of an example device or system that implements the method 1500 may perform functions at substantially the same time or in a specific sequence.

At block 1502, method 1500 commences the fatigue detection process, activating the components within the fatigue detection system 100. This initial operation sets the stage for a series of operations aimed at monitoring and analyzing the pilot's physiological and visual cues to detect any signs of fatigue that could compromise flight safety.

Proceeding to block 1504, the method engages the camera 120, which is communicatively coupled to the electronic flight bag (EFB) 110, to capture facial imagery of the pilot. The camera 120, potentially supplemented by an infrared camera 116 for enhanced low-light performance, acquires real-time visual data of the pilot's face. This data is used for the facial recognition unit 118, which utilizes facial recognition software 122 to process the imagery.

At block 1506 of method 1500, the operation focuses on the collection of biometric data from a wearable biometric sensor, WBS (e.g., the wristband 102), worn by the pilot. The WBS is tasked with gathering physiological data that is useful in assessing the pilot's current state of fatigue. This includes, but is not limited to, heart rate and heart rate variability, HRV.

The heart rate sensor within the WBS is responsible for monitoring the pilot's pulse, providing a stream of data that reflects the pilot's cardiovascular performance. This constant monitoring is to identify acute changes that might suggest an increase in fatigue levels.

Simultaneously, the ECG sensor within the WBS records the electrical activity associated with the pilot's heartbeats. The variability in the time intervals between these heartbeats, known as HRV, is a physiological marker that the fatigue detection system 100 uses to infer the pilot's level of stress or relaxation. Variations in HRV can be indicative of the onset of fatigue or the body's response to stressful situations.

At block 1508, method 1500 preprocesses the captured facial imagery and the collected biometric data. This preprocessing step may involve enhancing image quality for better facial recognition and filtering the biometric data to remove noise, thereby improving the accuracy of the subsequent analysis.

For example, the facial imagery captured by the camera undergoes a series of enhancements to improve the clarity and detail of the images. This may include adjusting brightness and contrast levels, applying filters to sharpen the image, and utilizing algorithms to stabilize the video feed to counteract any motion blur that may occur during flight turbulence. The goal is to achieve a level of image quality that facilitates accurate facial recognition, allowing the system to detect subtle changes in the pilot's facial expressions that are indicative of fatigue.

Simultaneously, the biometric data from the WBS, which includes heart rate and heart rate variability, HRV, may be filtered to remove any extraneous noise or artifacts. This may involve digital signal processing techniques such as band-pass filtering to isolate the relevant frequency components of the heart rate signal, or applying smoothing algorithms to the HRV data to ensure that the variability measured is truly reflective of the pilot's physiological state and not a result of transient or irrelevant factors.

The data preprocessing layer 208 within the fatigue detection system architecture is responsible for executing these operations. It ensures that the data is clean, accurate, and ready for the next stage of analysis. By preprocessing the facial imagery and biometric data, the fatigue detection system 100 enhances its ability to detect signs of fatigue with greater precision, thereby improving the overall effectiveness of the fatigue detection process.

At block 1510, method 1500 analyzes the preprocessed facial imagery and biometric data using a fatigue assessment engine 216. The fatigue assessment engine 216 employs algorithms to detect signs of fatigue by examining facial movements and eye metrics, as well as analyzing the biometric data for physiological signs of fatigue.

The facial recognition software 122, in some examples, analyzes the enhanced facial imagery for specific movements and expressions associated with fatigue. This includes monitoring the frequency of yawning, the rate of blinking, and the percentage of eyelid closure, known as PERCLOS. These facial movements and eye metrics are indicators of a pilot's alertness and can signal the onset of fatigue.

In parallel, the fatigue assessment engine 216 examines the biometric data, which includes heart rate and HRV, for physiological signs of fatigue. The fatigue assessment engine 216 looks for patterns within the heart rate data that may indicate stress or exhaustion, such as an unusually slow heart rate or a significant drop in HRV. These physiological signs are components in the assessment of fatigue, as they provide objective data on the pilot's physical state.

The analysis performed by the fatigue assessment engine 216 is a multi-faceted process that combines data from different sources to form a comprehensive understanding of the pilot's condition. By integrating facial recognition with biometric analysis, the fatigue assessment engine 216 can make informed decisions about the presence of fatigue.

At block 1512 of method 1500, the operation involves the generation of a fatigue score, which serves as a quantifiable measure of the pilot's level of fatigue. This score is derived from the comprehensive analysis conducted by the fatigue assessment engine 216, which has processed both the facial imagery and the biometric data.

The fatigue score may be calculated by aggregating the results of the analysis of facial movements, eye metrics, and physiological signs of fatigue. As depicted in FIG. 14A and FIG. 14B, the fatigue detection system 100 assigns points to various signs of fatigue based on their relevance and significance. For example, high-relevance signs such as frequent yawning, rapid blinking, and a high PERCLOS score contribute more points to the fatigue score, while lower-relevance signs contribute fewer points.

The scoring system, as outlined in the flowchart of FIG. 14A and FIG. 14B, takes into account the categorization of fatigue indicators and assigns points accordingly. These points are then summed, and if the total exceeds a certain threshold, it is indicative of a higher level of fatigue. The fatigue score reflects the cumulative evidence of fatigue gathered from the pilot's facial expressions and physiological state.

At decision block 1514, method 1500 determines whether the fatigue score exceeds a predetermined threshold. If the score is above the threshold, indicating significant fatigue, the method proceeds to block 1516; otherwise, it continues monitoring at block 1518.

At block 1516, method 1500 provides an alert to the pilot. This alert may be delivered through the WBS, which can provide a haptic feedback mechanism such as a vibration to notify the pilot discreetly.

At block 1518, if the fatigue score does not exceed the threshold, method 1500 continues to monitor the pilot without providing an alert. The system remains vigilant, continuously analyzing incoming data to ensure the pilot's fatigue level is assessed in real-time.

The sequence and decision-making process of method 1500 involve a continuous loop of data capture, analysis, and response, with the system dynamically adjusting its operations based on real-time data and the pilot's interaction with the EFB application. The system's design allows for the integration of additional sensors or data sources, and the method may be adapted to accommodate different aircraft configurations or regulatory environments. In some examples, the system may also include features to ensure data privacy and security, such as anonymizing data or employing encryption protocols for data transmission.

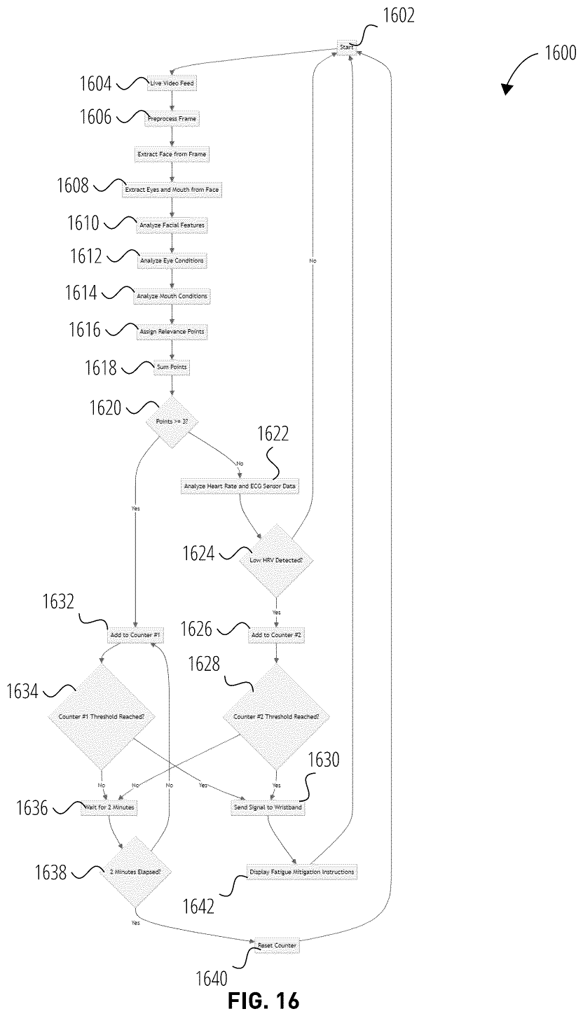

FIG. 16 is a flowchart illustrating a method of fatigue detection and management, according to some examples, of a fatigue detection system for pilots. Although the example method 1600 depicts a particular sequence of operations, the sequence may be altered without departing from the scope of the present disclosure. For example, some of the operations depicted may be performed in parallel or in a different sequence that does not materially affect the function of the method 1600. In some examples, different components of an example device or system that implements the method 1600 may perform functions at substantially the same time or in a specific sequence.

At block 1602, method 1600 commences the fatigue detection process. At block 1604, the method captures a live video feed from the camera integrated into the electronic flight bag (EFB). This video feed monitors the pilot's facial expressions and movements, which are indicative of fatigue.

At block 1606, method 1600 preprocesses the video frame to enhance the quality of the facial imagery. This step may involve adjusting the contrast or brightness to ensure that the facial features are clearly visible for analysis.

At block 1608, method 1600 extracts the face from the frame, isolating the pilot's facial features from the rest of the video feed. This targeted extraction is for focusing the analysis on the most relevant data.

At block 1610, method 1600 further refines the data by extracting the eyes and mouth from the face. These features are particularly telling for signs of fatigue, such as yawning and changes in blink rate.

At block 1612, method 1600 analyzes the facial features to identify any conditions indicative of fatigue. This analysis is performed by a facial recognition module that is configured to detect specific movements and metrics associated with fatigue.

At block 1614, method 1600 analyzes eye conditions, such as blink rate and PERCLOS, which are metrics for assessing fatigue. At block 1616, the method analyzes mouth conditions, including the frequency of yawning and other movements that may signal tiredness.

At block 1618, method 1600 assigns relevance points to the detected signs of fatigue. This scoring system quantifies the level of fatigue based on the observed indicators.

At decision block 1620, method 1600 determines if the sum of relevance points meets or exceeds a predetermined threshold. If the threshold is met, indicating significant fatigue, the method proceeds to block 1622; otherwise, it continues to monitor at block 1640.

At block 1622, method 1600 analyzes heart rate and ECG sensor data from the wearable biometric sensor (WBS). This physiological data provides an additional layer of information to corroborate the signs of fatigue detected through facial analysis.

At decision block 1624, method 1600 evaluates whether low heart rate variability (HRV) is detected. If low HRV is detected, the method proceeds to block 1626; otherwise, it continues to block 1628.

At block 1626, method 1600 adds to counter#1, which tracks the accumulation of fatigue points over time. At decision block 1628, method 1600 checks if the threshold for counter#1 is reached. If the threshold is reached, indicating persistent signs of fatigue, the method proceeds to block 1636; otherwise, it continues to block 1630.

At block 1630, method 1600 adds to counter#2, which may track a different aspect of fatigue detection, such as the duration or intensity of fatigue signs.

At decision block 1632, method 1600 evaluates whether counter#2's threshold is reached. If the threshold is reached, the method proceeds to block 1636; otherwise, it continues to block 1634.

At decision block 1634, method 1600 determines if a waiting period, such as 2 minutes, has elapsed since the last alert. If the waiting period has elapsed, the method proceeds to block 1636; otherwise, it continues to monitor at block 1640.

At block 1636, method 1600 sends a signal to the wristband to provide an alert to the pilot. This alert may be a tactile vibration that discreetly notifies the pilot of the need to take action to mitigate fatigue.

At decision block 1638, method 1600 checks if 2 minutes have elapsed since the last alert. If the waiting period has elapsed, the method proceeds to block 1642; otherwise, it continues to monitor at block 1640.

At block 1640, method 1600 continues to monitor the pilot without providing an alert, maintaining vigilance and readiness to respond to any emerging signs of fatigue.

At block 1642, method 1600 displays fatigue mitigation instructions on the EFB, providing the pilot with actionable recommendations to address the detected fatigue.

The sequence and decision-making process of method 1600 involve a continuous loop of data capture, analysis, and response, with the system dynamically adjusting its operations based on real-time data and the pilot's interaction with the EFB application. The system's design allows for the integration of additional sensors or data sources, and the method may be adapted to accommodate different aircraft configurations or regulatory environments. In some examples, the system may also include features to ensure data privacy and security, such as anonymizing data or employing encryption protocols for data transmission.

### Machine-Learning Pipeline 1800

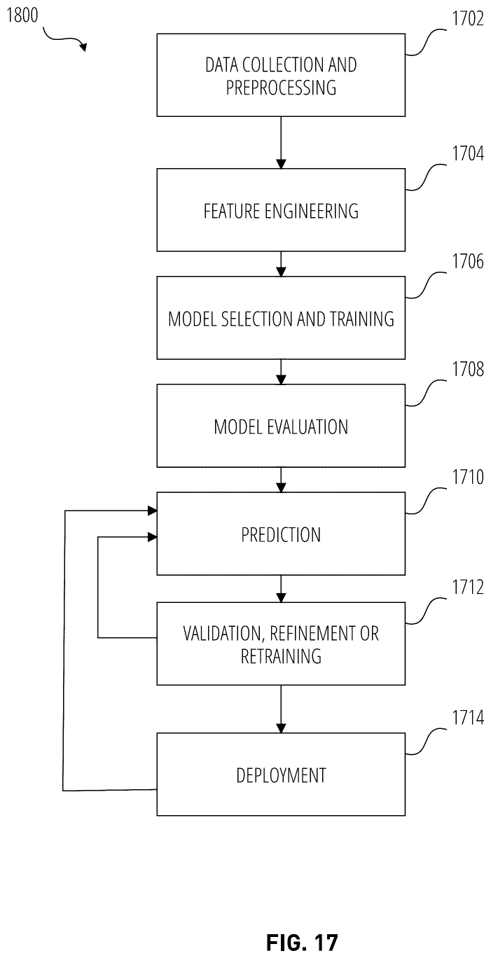

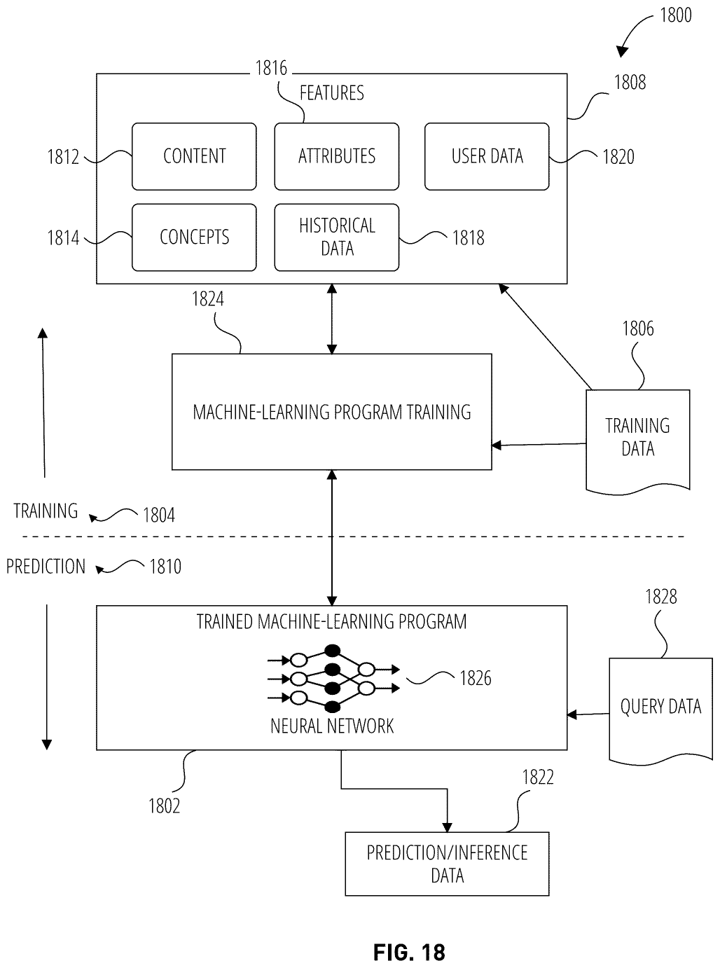

FIG. 17 is a flowchart depicting a machine-learning pipeline 1800, according to some examples. The machine-learning pipeline 1800 may be used to generate a trained model, for example the trained machine-learning program 1802 of FIG. 18, to perform operations associated with searches and query responses.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Training Phases 1804

Generating a trained machine-learning program 1802 involves a comprehensive machine-learning pipeline 1800 that encompasses several phases, each contributing to the development of an AI model capable of accurately predicting outcomes based on input data. The following narrative expands upon these phases, integrating the AI model and algorithm 124 and its use within the system, as well as the training process utilizing the Kaggle GPU service.

In the initial phase of data collection and preprocessing 1702, raw data is gathered and subjected to a series of cleansing operations to render it suitable for subsequent analysis. This high-level process may involve the elimination of redundant entries, rectification of incomplete data points, and transformation of the data into a format amenable to machine learning algorithms. At a more granular level, preprocessing might include normalization techniques to scale numerical data or encoding methods to convert categorical variables into a machine-readable form.

Feature engineering 1704 follows, where the cleansed data is further refined to extract or construct features that effectively predict the target variable. At a high level, this involves the identification and selection of relevant data attributes. On an intermediate level, this could entail the application of domain knowledge to create derived attributes or the use of dimensionality reduction techniques to distill the most informative features. In some examples, deep-level technical processes such as principal component analysis or autoencoders may be employed to transform the input data into a reduced set of features that retain the most relevant information.

Model selection and training 1706 is the subsequent phase where an appropriate machine learning algorithm is chosen to learn from the preprocessed and feature-engineered data. This phase may involve partitioning the dataset into subsets for training and validation, applying cross-validation techniques to assess model robustness, and fine-tuning model hyperparameters to optimize performance. In some examples, a variety of machine learning models, such as support vector machines, decision trees, or ensemble methods like random forests, may be evaluated to select the one that best fits the data characteristics.

Model evaluation 1708 entails the rigorous assessment of the trained model's predictive capabilities on a separate testing dataset. This phase diagnoses potential issues such as overfitting, where the model performs well on the training data but poorly on unseen data, or underfitting, where the model is too simplistic to capture the underlying data patterns. In some examples, metrics such as accuracy, precision, recall, and the F1 score are calculated to quantify model performance.

Prediction 1710 is the phase where the trained model is applied to new, unseen data to generate predictions. This is the practical application of the machine-learning program 1802, where it serves its intended purpose of making inferences based on the learned patterns from the training data.

Validation, refinement, or retraining 1712 involves the iterative improvement of the model based on new data or feedback obtained from the prediction phase. In some examples, this could include the incorporation of additional data to retrain the model or the adjustment of model parameters to better align with the observed outcomes.

Deployment 1714 is the final phase where the trained model is integrated into a larger system or application. This may involve the development of APIs for model access, the creation of user interfaces for interaction with the model, and the scaling of the system to handle large volumes of data efficiently.

In some examples, the AI model and algorithm 124, which is a component of the fatigue detection system 100, is trained using the Kaggle GPU service. This service provides the computational power to process large datasets and complex algorithms. When pilots opt to release their data, the EFB application 112 invokes an upload API to transmit the images to the dataset for labeling, processing, and future training or updates to the model.

The neural network 1826, which may be generated during the training phase 1804 and implemented within the trained machine-learning program 1802, is a hierarchical arrangement of neurons organized in layers. Each neuron computes a function, such as an activation function, based on the weighted inputs from the previous layer and a bias term. The output of this function is then propagated to the next layer's neurons. The connections between neurons have associated weights that are fine-tuned during the training phase to enhance the network's predictive accuracy.

In some examples, the neural network 1826 may take the form of various architectures, such as Convolutional Neural Networks (CNNs) for image-based tasks, Recurrent Neural Networks (RNNs) for sequential data processing, or more complex structures like Long Short-Term Memory Networks (LSTMs) for capturing long-term dependencies in time-series data.

The generative aspect of the AI model may involve techniques such as Generative Adversarial Networks (GANs) for creating realistic synthetic data, or Transformer models that leverage attention mechanisms to generate outputs based on the relationships within the input data. These generative models can produce a range of content, from textual summaries to synthetic images, which resemble the training data but are not identical copies.

The output of the generative AI model, which is part of the prediction/inference data 1822, includes a variety of predictions and generated content based on the features identified during the feature engineering phase. This output is the culmination of the machine-learning pipeline 1800, demonstrating the model's ability to apply learned knowledge to new data scenarios.

In the context of the fatigue detection system 100, the generative AI model's output may include predictive assessments of pilot fatigue levels, recommendations for fatigue mitigation, or even potential scheduling adjustments. The AI model and algorithms 124, having been trained on a comprehensive dataset with tagged facial images containing symptoms of fatigue, utilize this training to recognize a wide array of fatigue symptoms with high accuracy.

The generative aspect of the AI model is particularly adept at creating outputs that are not direct replicas of the training data but are instead new and insightful predictions that can aid in real-time decision-making. For instance, the AI model and algorithms 124 may predict the onset of fatigue in a pilot before it becomes apparent, based on subtle changes in biometric data such as heart rate variability or micro-expressions captured by the camera 120.

Furthermore, the output of the AI model and algorithm 124 may enhance the functionality of the fatigue assessment engine 216. By generating predictions that are tailored to the individual pilot's historical data 1818 and current user data 1820, the AI model and algorithms 124 can provide personalized advice that is displayed through the EFB interface 254 or the pilot personal device interface 256.

FIG. 18 is a diagrammatic representation illustrating the training and use of a machine-learning program within a fatigue detection system, according to some examples. The diagram shows an example relationship between training data 1806, the trained machine-learning program 1802, and how it processes input data to generate predictions related to pilot fatigue.

The trained machine-learning program 1802 is the central component of the diagram, which includes a neural network 1826 that has been trained to recognize patterns associated with pilot fatigue. The neural network 1826 processes input data through multiple layers to extract features and make predictions about fatigue levels.

The training of the machine-learning program involves several data inputs shown on the left side of the diagram. Historical data 1818 includes previously collected fatigue incidents and biometric readings from pilots. User data 1820 comprises information specific to individual pilots, which may be used to personalize fatigue detection. Content 1812 represents the various types of data collected, such as facial imagery and biometric readings.

The features 1816 component represents the extracted characteristics from the raw data that are most relevant for fatigue detection, such as blink rate patterns or heart rate variability metrics. Attributes 1814 are specific properties of the data that contribute to the feature extraction process. Concepts 1808 represents the higher-level understanding of fatigue that the system aims to model.

Training data 1806 is compiled from these various inputs and used in the training phase 1804 to develop the neural network 1826 within the trained machine-learning program 1802. The training process involves exposing the neural network to examples of both fatigued and non-fatigued states to learn the distinguishing patterns.

On the right side of the diagram, query data 1828 represents new inputs from the wristband sensors and camera that are fed into the trained machine-learning program 1802 during actual flight operations. The program processes this data and generates prediction/inference data 1822, which includes the fatigue assessment and recommended mitigation strategies.

The bidirectional arrows between components indicate the flow of information throughout the system, with data being processed, analyzed, and transformed at each stage to support the fatigue detection capabilities of the system.

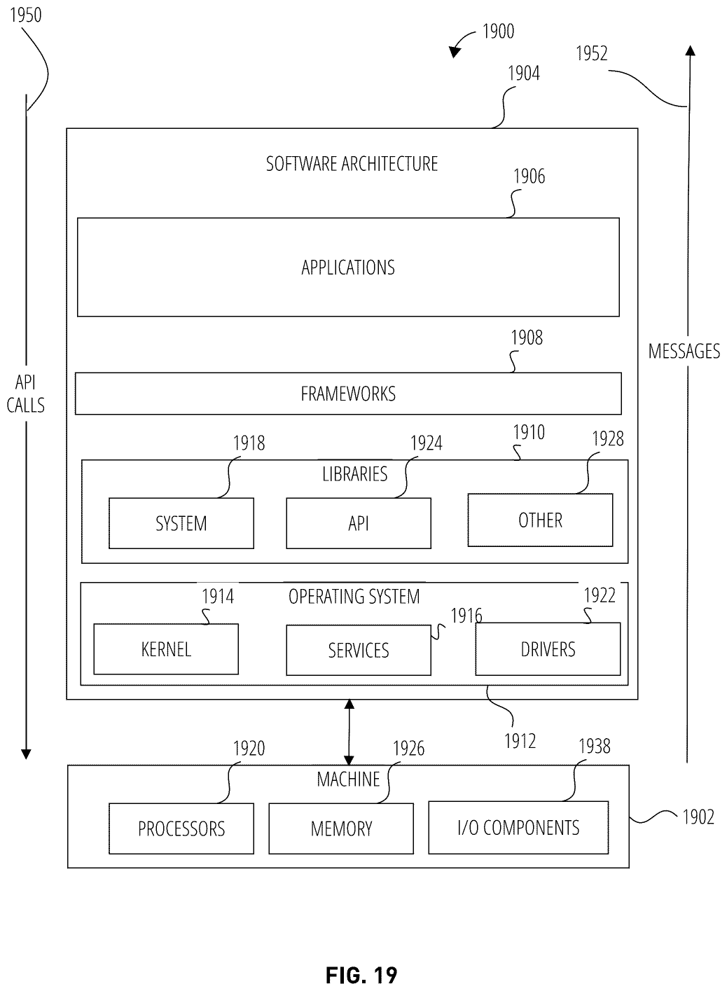

FIG. 19 is a block diagram 1900 showing a software architecture 1904, which can be installed on any devices like smartphones, tablets, or computers. The software architecture 1904 runs on hardware like a machine with processors 1920, memory 1926, and I/O components 1938. In this example, the software architecture 1904 has layers that each provide specific functions. The layers are applications 1906, frameworks 1908, libraries 1910, and an operating system 1912.

In operation, the applications 1906 make API calls 1950 through the software stack and get messages 1952 back responding to the API calls 1950.

The operating system 1912 handles hardware resources and common services. It includes a kernel 1914, services 1916, and drivers 1922. The kernel 1914 abstracts the hardware for the other software. It handles memory, processing, components, networking, security, and more. The services 1916 provide common services to the layers. The drivers 1922 control and interface with the hardware. Examples are display, camera, Bluetooth, flash memory, USB, Wi-Fi, audio, and power drivers.

The libraries 1910 have low-level code the applications 1906 use. The libraries 1910 include system libraries 1918 like the C standard with functions for memory, strings, math, and more. They also have API libraries 1924 like media, graphics, database, web, and other libraries 1928. The graphics libraries render 2D and 3D graphics.

The frameworks 1908 have high-level common infrastructure the applications 1906 use. For example, they provide graphical user interfaces, resource management, location services, and other APIs.

The applications 1906 execute program functions using languages like Objective-C, Java, C++, C, or assembly. For example, a third-party application may be made with the iOS or Android SDK by another company. It uses the operating system's 1912 APIs.

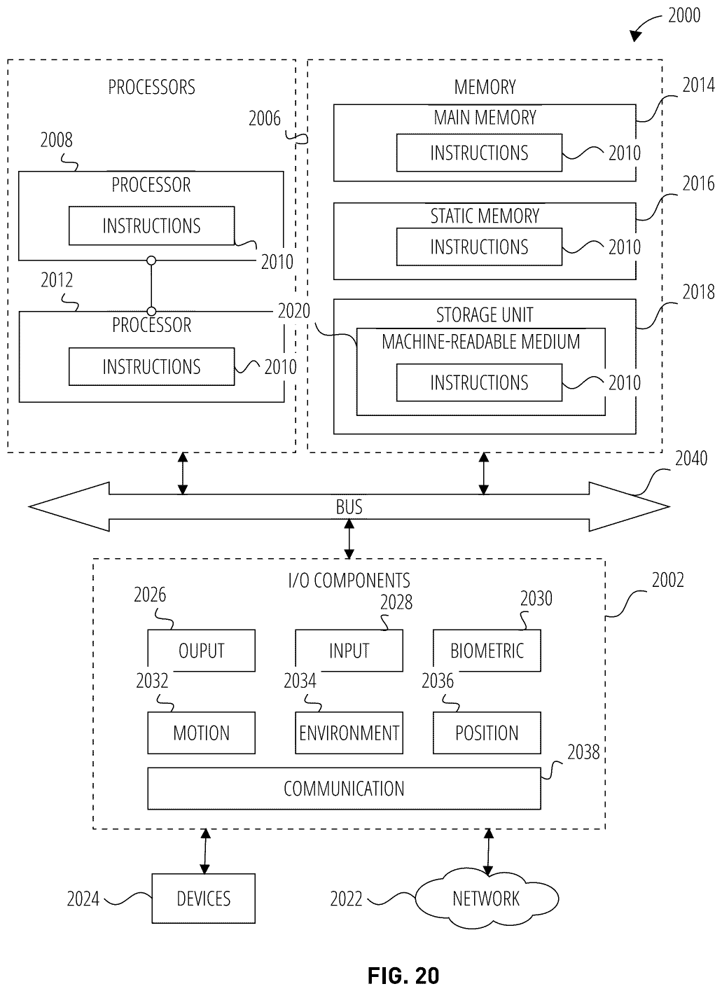

FIG. 20 is a diagrammatic representation of the machine 2000 within which instructions 2010 (e.g., software, a program, an application, an applet, an app, or other executable code) for causing the machine 2000 to perform any one or more of the methodologies discussed herein may be executed. For example, the instructions 2010 may cause the machine 2000 to execute any one or more of the methods described herein. The instructions 2010 transform the general, non-programmed machine into a particular machine 2000 programmed to carry out the described and illustrated functions in the manner described. The machine 2000 may operate as a standalone device or be coupled (e.g., networked) to other machines. In a networked deployment, the machine 2000 may operate in the capacity of a server machine or a client machine in a server-client network environment, or as a peer machine in a peer-to-peer (or distributed) network environment. The machine 2000 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2010, sequentially or otherwise, that specify actions to be taken by the machine 2000. Further, while a single machine 2000 is illustrated, the term “machine” may include a collection of machines that individually or jointly execute the instructions 2010 to perform any one or more of the methodologies discussed herein.

The machine 2000 may include processors 2004, memory 2006, and I/O components 2002, which may be configured to communicate via a bus 2040. In some examples, the processors 2004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), a Tensor Processing Unit (TPU), a Neural Processing Unit (NPU), a Vision Processing Unit (VPU), a Machine Learning Accelerator (MLA), a Cryptographic Acceleration Processor, a Field-Programmable Gate Array (FPGA), a Quantum Processor, another processor, or any suitable combination thereof) may include, for example, a processor 2008 and a processor 2012 that execute the instructions 2010.

Although FIG. 20 shows multiple processors 2004, the machine 2000 may include a single processor with a single core, a single processor with multiple cores (e.g., a multi-core processor), multiple processors with a single core, multiple processors with multiples cores, or any combination thereof. Modern processor architectures include superscalar, very long instruction word (VLIW), vector processor, multi-core, manycore, neuromorphic, and quantum architectures.

The memory 2006 includes a main memory 2014, a static memory 2016, and a storage unit 2018, both accessible to the processors 2004 via the bus 2040. The main memory 2006, the static memory 2016, and storage unit 2018 store the instructions 2010 embodying any one or more of the methodologies or functions described herein. The instructions 2010 may also reside, wholly or partially, within the main memory 2014, within the static memory 2016, within machine-readable medium 2020 within the storage unit 2018, within the processors 2004 (e.g., within the processor's cache memory), or any suitable combination thereof, during execution thereof by the machine 2000.

The I/O components 2002 may include various components to receive input, provide output, produce output, transmit information, exchange information, or capture measurements. The specific I/O components 2002 included in a particular machine depend on the type of machine. For example, portable machines such as mobile phones may include a touch input device or other such input mechanisms, while a headless server machine will likely not include such a touch input device. The I/O components 2002 may include many other components not shown in FIG. 20. In various examples, the I/O components 2002 may include output components 2026 and input components 2028. The output components 2026 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 2028 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2002 may include biometric components 2030, motion components 2032, environmental components 2034, or position components 2036, among a wide array of other components. For example, the biometric components 2030 could include components to detect expressions (e.g., hand gestures, facial expressions, vocal expressions, body movements, or eye tracking) or measure biosignals (e.g., heart rate, blood pressure, body temperature, perspiration, or brain waves) in an aggregate, anonymous way that does not identify individuals. Technologies like facial recognition, fingerprint identification, voice identification, retinal scanning, or electroencephalogram-based identification are of course only be implemented with explicit informed consent from users, if at all. When biometric data is collected, it is minimized, encrypted, and accessed only for authorized purposes. Users are able to opt-out of biometric collection by the biometric components 2030 and have their data permanently deleted. With proper consent, security protections, data minimization, and respect for user privacy, certain biometric components may be implemented ethically.

The motion components 2032 include acceleration sensor components (e.g., accelerometer), gravitation sensor components, rotation sensor components (e.g., gyroscope). The environmental components 2034 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2036 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2002 further include communication components 2038 operable to couple the machine 2000 to a network 2022 or devices 2024 via respective coupling or connections. For example, the communication components 2038 may include a network interface Component or another suitable device to interface with the network 2022. In further examples, the communication components 2038 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2024 may be another machine or any of a wide variety of peripheral devices (e.g., a peripheral device coupled via a USB).

Moreover, the communication components 2038 may detect identifiers or include components operable to detect identifiers. For example, the communication components 2038 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 2038, such as location via Internet Protocol (IP) geolocation, location via Wi-Fi® signal triangulation, or location via detecting an NFC beacon signal that may indicate a particular location.

The various memories (e.g., main memory 2014, static memory 2016, and/or memory of the processors 2004) and/or storage unit 2018 may store one or more sets of instructions and data structures (e.g., software) embodying or used by any one or more of the methodologies or functions described herein. These instructions (e.g., the instructions 2010), when executed by processors 2004, cause various operations to implement the disclosed examples.

The instructions 2010 may be transmitted or received over the network 2022, using a transmission medium, via a network interface device (e.g., a network interface component included in the communication components 2038) and using any one of several well-known transfer protocols (e.g., hypertext transfer protocol (HTTP)). Similarly, the instructions 2010 may be transmitted or received using a transmission medium via a coupling (e.g., a peer-to-peer coupling) to the devices 2024.

### Data Security/Security Layer 240

In the realm of data security and privacy for the fatigue detection system 100, the safeguarding of transmitted data may be implemented through a structured encryption strategy. At the most fundamental level, this strategy encompasses the conversion of sensitive information into a ciphered format, which is impervious to unauthorized interpretation without the corresponding decryption key.

Delving into a more detailed layer, the encryption methodology may incorporate established cryptographic algorithms. For instance, the Advanced Encryption Standard (AES) or the Rivest-Shamir-Adleman (RSA) algorithm could be employed to encrypt the image data. These algorithms are recognized for their strength and have been adopted globally to protect data integrity.

In some examples, the encryption is applied in an end-to-end manner. This means that the data, once it departs from the source device, such as the wearable biometric sensor (WBS) or the electronic flight bag (EFB) application, remains in an encrypted state throughout its journey until it reaches the intended recipient. Specifically, image data is encrypted into a secure image file before being sent to servers. Concurrently, a Client Reporting System (CRS), which may be integrated with the employer's system, is designed to handle these encrypted files. The pilot's device, in turn, receives an encrypted JSON file containing the fatigue model's results. This file, encoded using a secure data structure, ensures that the pilot's biometric and facial recognition data is transmitted securely.

When addressing the privacy and security of the pilots' biometric data, a multi-tiered approach is adopted. At a broad level, the strategy is to limit the exposure of biometric data to potential security threats by managing the data's processing and storage locations.

At an intermediate level, pilots are provided with the autonomy to decide whether their images are to be included in the model training dataset. This empowers pilots with control over their personal data. Moreover, the biometric data is confined to local processing on the pilot's device, which negates the need for cloud-based transmission, thereby reducing the risk of data breaches.

In some examples, the local processing of biometric data on the pilot's device entails the use of data structures such as local databases or secure storage modules within the device's architecture. This localized approach to data handling not only fortifies the security of the data but also facilitates immediate access for the pilot, ensuring that the integrity and confidentiality of the data are maintained. The local databases may store various data points, such as heart rate and HRV data, for the fatigue assessment engine to perform its analysis. The secure storage modules ensure that the data, once stored, cannot be accessed by any unauthorized entity, preserving the pilot's privacy. In the realm of data security and privacy for the fatigue detection system, the safeguarding of transmitted data is implemented through a structured encryption strategy. At the most fundamental level, this strategy encompasses the conversion of sensitive information into a ciphered format, which is impervious to unauthorized interpretation without the corresponding decryption key.

Delving into a more detailed layer, the encryption methodology may incorporate established cryptographic algorithms. For instance, the Advanced Encryption Standard (AES) or the Rivest-Shamir-Adleman (RSA) algorithm could be employed to encrypt the image data. These algorithms are recognized for their strength and have been adopted globally to protect data integrity.

In some examples, the encryption is applied in an end-to-end manner. This means that the data, once it departs from the source device, such as the wearable biometric sensor (WBS) or the electronic flight bag (EFB) application, remains in an encrypted state throughout its journey until it reaches the intended recipient. Specifically, image data is encrypted into a secure image file before being sent to the servers. Concurrently, the Client Reporting System (CRS), which may be integrated with the employer's system, is designed to handle these encrypted files. The pilot's device, in turn, receives an encrypted JSON file containing the fatigue model's results. This file, encoded using a secure data structure, ensures that the pilot's biometric and facial recognition data is transmitted securely.

When addressing the privacy and security of the pilots' biometric data, a multi-tiered approach is adopted. At a broad level, the strategy is to limit the exposure of biometric data to potential security threats by managing the data's processing and storage locations.

At an intermediate level, pilots are provided with the autonomy to decide whether their images are to be included in the model training dataset. This empowers pilots with control over their personal data. Moreover, the biometric data is confined to local processing on the pilot's device, which negates the need for cloud-based transmission, thereby reducing the risk of data breaches.

In some examples, the local processing of biometric data on the pilot's device entails the use of data structures such as local databases or secure storage modules within the device's architecture. This localized approach to data handling not only fortifies the security of the data but also facilitates immediate access for the pilot, ensuring that the integrity and confidentiality of the data are maintained. The local databases may store various data points, such as heart rate and HRV data, for the fatigue assessment engine to perform its analysis. The secure storage modules ensure that the data, once stored, cannot be accessed by any unauthorized entity, preserving the pilot's privacy.

### Fatigue Mitigation Advice

The fatigue detection system 100 is designed to provide personalized fatigue mitigation advice to pilots, enhancing their ability to manage fatigue and maintain operational safety. This advice is generated through a sophisticated analysis of the type of fatigue exhibited by the pilot, which is categorized into two primary types: active fatigue and passive fatigue.

Active fatigue is typically a consequence of high-stress environments and mental overload. Pilots operating under such conditions may experience a decrease in cognitive performance and an increased risk of errors. To counteract active fatigue, the system may suggest mental breaks or specific breathing exercises tailored to alleviate stress and cognitive burden. These recommendations are generated based on the system's assessment of the pilot's current state, which includes analyzing biometric data and performance metrics indicative of stress and mental exertion.

On the other hand, passive fatigue is often a result of prolonged periods of low activity, which can lead to drowsiness or sleepiness. In such scenarios, the system's advice may include recommendations to consume caffeine or to take a longer nap before the flight, if the schedule permits. These suggestions aim to stimulate alertness and reduce the sensation of tiredness, thereby preparing the pilot for the demands of flight.

In generating personalized fatigue mitigation advice, the system also considers the route data, which includes the duration of the flight, the time of day, and any specific pilot duties that may impact the type of advice provided. This contextual information allows the system to tailor its recommendations to the unique circumstances of each flight, ensuring that the advice is both practical and relevant.

However, there are limitations and considerations that the system takes into account when providing fatigue mitigation advice. For example, during phases of flight, such as takeoff and landing, certain recommendations, like taking a longer nap, may not be feasible due to the demands of piloting the aircraft. In such instances, the system will offer alternative advice that is more suitable for the situation. This may include short-term strategies to boost alertness, such as engaging in light physical activity or utilizing quick relaxation techniques that can be performed within the confines of the cockpit.

The system's ability to generate personalized fatigue mitigation advice is a testament to its advanced analytical capabilities. By considering various factors such as the type of fatigue, flight route data, and the specific constraints of flight operations, the system provides pilots with actionable guidance to effectively manage fatigue. This not only contributes to the well-being of pilots but also plays a role in maintaining the safety and efficiency of flight operations.

### Regulatory Compliance

The fatigue detection system 100, which includes the provision of personalized fatigue mitigation advice, has been developed with careful consideration of aviation regulations and standards for pilot monitoring. The system's compliance with regulatory requirements is a key aspect of its design and functionality.

The Electronic Flight Bag (EFB), a component of the fatigue detection system 100 is recognized as an avionics system. However, the software itself is classified as Type A EFB software by the Federal Aviation Administration (FAA). This classification is significant because it delineates the level of criticality and regulatory oversight associated with the software. Type A EFB software is characterized by its low impact on flight operations, meaning that a failure of the software does not pose a risk to the safety of the flight. As a result, Type A software is not subject to the stringent regulations that govern higher-risk avionics systems.

In practical terms, this classification means that the fatigue detection system 100 does not require prior FAA certification or testing before it can be commercially launched. This allows for a more streamlined introduction of the fatigue detection system 100 into the aviation industry, facilitating its adoption by airlines and pilots without the delays and complexities associated with certification processes.

The system's approach to regulatory compliance is reflected in its features, including the generation of personalized fatigue mitigation advice. The advice provided by the system is designed to be in harmony with aviation standards, ensuring that recommendations do not conflict with the pilot's duties or the operational requirements of the flight. For instance, the system's advice takes into account the critical phases of flight, such as takeoff and landing, and adjusts its suggestions accordingly to maintain compliance with safety protocols.

Furthermore, the system's adherence to data security and privacy standards, as previously described, aligns with regulatory expectations for the protection of sensitive pilot information. The end-to-end encryption of data, local processing of biometric data, and the ability for pilots to opt out of data sharing are all measures that demonstrate the system's commitment to regulatory compliance in the realm of data handling.

The system's classification as Type A EFB software by the FAA, along with its built-in regulatory compliance features, positions it as a reliable and safe solution for pilot fatigue monitoring. The system's ability to provide personalized fatigue mitigation advice without compromising regulatory standards is a testament to its thoughtful design and its potential to enhance pilot well-being and flight safety.

### Installation and/Maintenance and Support Module 232

The installation and maintenance of the fatigue detection system 100 are designed with user-friendliness and simplicity in mind, ensuring that pilots can integrate the system into their workflow with minimal disruption.

For installation, the process may be straightforward. Pilots securely mount their device in a position that allows for unobstructed visibility of their face, such as attaching it to the windshield using a window mount. This placement is helpful for the system's facial recognition software, which is part of the fatigue assessment engine, to function correctly. Upon activation of the application, pilots are prompted to position themselves so that the camera can capture their full face.

Once the initial setup is complete, pilots enter pertinent flight details into the system, such as the flight route and routing number. This information is used by the system to provide contextually relevant fatigue mitigation advice and to ensure that the advice is aligned with the specific requirements of the flight, as previously described.

Regarding maintenance and calibration, the system requires minimal upkeep to ensure accurate functionality. Pilots are responsible for keeping the application up to date with the latest software updates, which may include enhancements to the AI model and algorithm 124, improvements to the encryption protocols for data security, and refinements to the personalized fatigue mitigation advice. Additionally, pilots must verify that their devices meet the specifications for the system to operate effectively.

For the wearable biometric sensor (WBS), which is a part of the system's data acquisition layer, pilots need to ensure that it is fully charged and maintains a stable Bluetooth connection with their device. This connection allows the seamless transmission of biometric data, which the system uses to assess the pilot's fatigue level and generate appropriate advice.

If the system includes the optional infrared (IR) camera, which enhances the system's capability to capture facial imagery in low-light conditions, pilots must connect it to their device. This connection can be established either via a wired connection or through Bluetooth, depending on the device's support for multi-pairing options. The infrared camera 116 works in conjunction with the facial recognition unit 118 and facial recognition software 122 to ensure effective fatigue detection even during night flights or in cockpit environments with limited lighting.

The installation and maintenance of component 100 are designed to be as user-friendly and low-maintenance as possible, allowing pilots to focus on their primary responsibilities while benefiting from the system's advanced fatigue monitoring and mitigation capabilities. The system's intuitive setup, combined with straightforward maintenance procedures, ensures that it remains a reliable tool for enhancing pilot safety and well-being.

### Example Technical Problems and Solutions

Real-time Fatigue Detection: The fatigue detection system 100, according to some examples, offers a technical solution to the challenge of real-time fatigue detection by employing a sophisticated combination of facial recognition technology and biometric data analysis. This integrated approach enables the system to identify signs of fatigue in pilots as they occur, thereby enhancing flight safety and operational efficiency.

The fatigue assessment engine 216 is responsible for the real-time analysis of data collected from two primary sources: the pilot's facial expressions and physiological signals. The fatigue detection system 100 utilizes an electronic flight bag (EFB) equipped with a camera 120 that captures facial imagery of the pilot. This imagery is processed by facial recognition software 122, which is designed to detect specific facial movements and eye metrics associated with fatigue, such as yawning, drooping eyelids, and slow blink rates.

In parallel, fatigue detection system 100 includes a wearable biometric sensor (WBS), such as a wristband 102, which is equipped with an ECG sensor 104 and a heart rate sensor 106. These sensors continuously monitor the pilot's physiological data, including heart rate variability (HRV), which is a key indicator of the autonomic nervous system's response to stress and fatigue. The WBS is also integrated with a vibration alert component 108 that serves as an immediate notification system for the pilot when signs of fatigue are detected.

The data acquisition layer 202 of fatigue detection system 100 operates to use both facial imagery and biometric data are captured in real-time. The data preprocessing layer 208, which includes an image preprocessing subsystem 210 and a signal processing subsystem 212, refines the raw data to remove noise and enhance the quality of the information before it is analyzed.

The core analysis layer 214, powered by the fatigue assessment engine 216, integrates the preprocessed data from both the facial recognition module 204 and the biometric sensor module 206. By employing machine learning algorithms within the AI model and algorithms 124, the system can accurately assess the pilot's state and detect signs of fatigue in real-time.

The decision and alerting layer 218, specifically the alert generation module 220, takes the analysis results and determines whether an alert should be issued. If the pilot's fatigue level exceeds the predetermined threshold, the alert generation module 220 activates the haptic feedback mechanism in the WBS to inform the pilot.

The user interface layer 252, which includes the EFB interface 254 and the pilot personal device interface 256, serves as the primary point of interaction for pilots. It displays the fatigue mitigation advice and alerts in a clear and concise manner, allowing pilots to take immediate action to counteract fatigue.

In summary, system 100 provides a technical solution to real-time fatigue detection by leveraging advanced facial recognition, biometric monitoring, and machine learning technologies. The system's ability to process and analyze data in real-time ensures that pilots are alerted to the onset of fatigue promptly, enabling them to maintain high levels of alertness and safety throughout flight operations.

Integration with Existing Pilot Equipment: The fatigue detection system 100 integrates with existing pilot equipment, for example the electronic flight bag (EFB), to enhance its usability and adoption. The EFB, a digital tool used for managing flight-related tasks and documentation, serves as an example interface for the system. The fatigue detection system 100 is designed to complement the EFB by adding fatigue detection capabilities without disrupting the pilot's workflow or requiring significant changes to the cockpit environment.

The integration is facilitated by the EFB application 112, which may be a software component of fatigue detection system 100 that runs on the EFB's hardware. The EFB application 112 is configured to interact with the EFB interface 114, which serves as the communication bridge between the application and the other components of the fatigue detection system. This integration ensures that the EFB can display personalized fatigue mitigation advice and serve as the primary user interface for the pilot.

For the fatigue detection system 100 to function correctly, it may rely on the EFB's processing unit, which may consist of a high-performance CPU and sufficient RAM, to run the fatigue assessment engine's complex algorithms. The EFB's display, designed for high visibility under various lighting conditions, presents the fatigue mitigation advice and alerts in a clear and concise manner, ensuring that the pilot can easily understand and act upon the recommendations.

The EFB's connectivity options, such as Wi-Fi, Bluetooth, and cellular networks, enable real-time data synchronization with the airline's operations center. This allows for the transmission of fatigue metrics and the receipt of updated flight information, which the system uses to tailor the fatigue mitigation advice. Additionally, the EFB's internal storage securely retains the pilot's biometric data locally, ensuring privacy and compliance with data protection regulations.

The fatigue detection system 100 may utilize the EFB's built-in sensors, such as accelerometers and gyroscopes, to detect and analyze the pilot's movements and posture as additional indicators of fatigue. The system's software components are designed to be compatible with the EFB's operating system, whether it is iOS, Android, or another platform, allowing for easy updates and maintenance.

By integrating with the EFB, the fatigue detection system 100 provides a technical solution that enhances the existing pilot equipment with advanced fatigue detection capabilities. This integration ensures that the system is both practical and effective, offering a user-friendly approach to managing pilot fatigue without introducing new hardware or complex installation procedures.

Data Preprocessing for Accuracy: The fatigue detection system 100 incorporates a data preprocessing module that plays a role in enhancing the accuracy of fatigue detection by improving the quality of the captured facial imagery. This module is a component of the system's data preprocessing layer 208, which is tasked with preparing the raw data for detailed analysis by the core analysis layer 214.

The data preprocessing module includes an image preprocessing subsystem 210, which is responsible for refining the visual data captured by the camera 120 integrated into the EFB 110. The subsystem applies various image enhancement techniques, such as adjusting contrast, brightness, and sharpness, to ensure that the pilot's facial features are clearly visible. This is particularly important in the cockpit environment, where lighting conditions can vary significantly, potentially impacting the quality of the captured imagery.

By enhancing the image quality, the image preprocessing subsystem 210 ensures that the facial recognition software 122 can accurately identify and analyze facial movements and eye metrics associated with fatigue. For example, the software needs to detect subtle changes in blink rate, eyelid movement, or yawning frequency, which are indicators of a pilot's alertness level. Without clear and high-quality imagery, the risk of misinterpreting these signs increases, which could lead to false positives or negatives in fatigue detection.

In addition to visual enhancements, the data preprocessing module may also include noise reduction algorithms that filter out irrelevant visual artifacts or background clutter that could interfere with the facial recognition process. This step is for isolating the pilot's face and ensuring that the system focuses on the most relevant data for fatigue assessment.

The signal processing subsystem 212, another part of the data preprocessing layer 208, complements the image preprocessing by filtering and refining the biometric data collected by the WBS. This includes removing noise from the heart rate and HRV data, for assessing the physiological aspects of fatigue.

The data preprocessing module's ability to enhance the quality of both facial imagery and biometric data ensures that the subsequent analysis by the fatigue assessment engine 216 is based on accurate and reliable information. This technical solution provided by the fatigue detection system 100 is for the real-time and precise detection of pilot fatigue, ultimately contributing to the safety and efficiency of flight operations.

Biometric Data Analysis: The fatigue detection system 100, in some examples, integrates the analysis of biometric data to provide a comprehensive assessment of the pilot's physiological state, which is an aspect of detecting pilot fatigue. The fatigue detection system 100 includes a wearable biometric sensor (WBS), such as a wristband 102, that is equipped with sensors like an ECG sensor 104 and a heart rate sensor 106. These sensors operate to capture physiological data that reflects the pilot's physical condition in real-time.

The heart rate sensor 106 measures the pilot's heart rate, which is an indicator of the body's response to stress and fatigue. A decrease in heart rate can be a sign of passive fatigue or drowsiness, which could impair a pilot's ability to maintain alertness during flight operations. The ECG sensor 104, on the other hand, captures electrocardiogram data, which is used to calculate heart rate variability (HRV). HRV is the variation in the time interval between heartbeats and is a marker of the autonomic nervous system's activity. Fluctuations in HRV are closely linked to the body's stress response and can be indicative of fatigue.

The biometric sensor module 206 within the data acquisition layer 202 collects this data and transmits it to the data preprocessing layer 208, where the signal processing subsystem 212 filters and refines the data. This preprocessing step is to remove or reduce noise and artifacts that could interfere with the accuracy of the fatigue assessment.

Once preprocessed, the biometric data is fed into the core analysis layer 214, where the fatigue assessment engine 216 may employ machine learning algorithms to analyze the data. The AI model and algorithms 124 within the fatigue assessment engine 216 are trained on a comprehensive dataset that includes physiological signals and facial imagery tagged with fatigue symptoms. This training enables the fatigue detection system 100 to recognize complex patterns associated with fatigue and to make accurate assessments of the pilot's state.

By incorporating biometric data analysis into the fatigue detection process, the fatigue detection system 100 can detect signs of fatigue that may not be visible through facial recognition alone. The combination of heart rate and HRV data with facial analysis provides a multi-modal approach to fatigue detection, enhancing the system's reliability and accuracy.

The technical solution provided by the fatigue detection system 100 for biometric data analysis may be helpful in that the fatigue detection is not only based on visual cues but also grounded in the physiological responses of the pilot. This assessment of the pilot's physiological state is useful for the early and accurate detection of fatigue.

Personalized Fatigue Assessment: The fatigue detection system 100, in some examples, enhances the accuracy of fatigue assessments by personalizing the detection process for each individual pilot through the local storage of biometric data. This approach to data management is an aspect of the system's data privacy and security measures, as well as its technical capability to provide tailored fatigue assessments.

The wearable biometric sensor (WBS), such as the wristband 102, is a component in collecting biometric data, including heart rate and heart rate variability (HRV), from the pilot. This data is indicative of the pilot's physiological state and detects signs of fatigue. Instead of transmitting this sensitive data over potentially insecure networks or storing it in a cloud environment where it could be vulnerable to unauthorized access, the fatigue detection system 100 may, in some examples, process and store the data locally on the pilot's device, as indicated by the local storage 130 within the data storage 128.

Local processing and storage of biometric data allow the fatigue detection system 100 to build a personalized profile for each pilot over time. By analyzing data trends specific to an individual, the fatigue detection system 100 can more accurately identify deviations from the pilot's baseline physiological state, which may signal the onset of fatigue. This personalized approach accounts for the natural variability in heart rate and HRV between different individuals, which can be influenced by factors such as fitness levels, age, and stress tolerance.

The fatigue assessment engine 216 utilizes the locally stored biometric data to refine its machine learning algorithms, ensuring that the fatigue detection is customized to the individual characteristics of each pilot. The AI model and algorithms 124 within the fatigue assessment engine 216 are thus able to learn from the pilot's historical data, enhancing the predictive accuracy of the system.

Furthermore, the personalized fatigue assessment provided by the fatigue detection system 100 is dynamic and continuously improves as more data is collected. Pilots who opt to contribute their data anonymously can further enhance the model's accuracy, allowing the fatigue detection system 100 to adapt to a broader range of physiological responses and improve its generalizability.

The technical solution of local data storage and processing in the fatigue detection system 100 not only safeguards the privacy and security of the pilot's biometric data but also enables a personalized and accurate fatigue assessment. This personalized approach may be helpful for the early detection of fatigue, allowing pilots to take timely actions to mitigate fatigue and maintain the highest levels of safety during flight operations.

Haptic Feedback for Alerts: The fatigue detection system 100, in some examples, incorporates a haptic feedback mechanism within the wearable biometric sensor (WBS), such as the wristband 102, to provide non-disruptive alerts to the pilot when signs of fatigue are detected. This haptic feedback mechanism is a feature of the system's alerting strategy, designed to notify the pilot in a manner that is both immediate and subtle, ensuring that the pilot's attention is not unduly diverted from flying the aircraft.

The wristband 102 is equipped with a vibration alert component 108, which is activated when the fatigue assessment engine 216 determines that the pilot's fatigue level has exceeded a predetermined threshold. The decision and alerting layer 218, specifically the alert generation module 220, is responsible for processing the analysis results from the fatigue assessment engine 216 and determining whether an alert should be issued.

When an alert is triggered, the vibration alert component 108 delivers a tactile stimulus to the pilot's wrist. The intensity and pattern of the vibrations may be configured to be noticeable enough to alert the pilot without causing alarm. This haptic feedback is effective in the cockpit environment, where auditory alerts may be missed due to ambient noise, and visual alerts may be overlooked if the pilot's gaze is directed elsewhere.

The haptic feedback mechanism in the fatigue detection system 100 serves several example functions:
1. Immediate Notification: The tactile alert provides an instant notification of detected fatigue, allowing the pilot to take prompt action.
2. Non-Disruptive Alerting: Unlike auditory or visual alerts that may be distracting or disruptive, the haptic feedback is a gentle yet effective way to gain the pilot's attention without disrupting cockpit operations.
3. Enhanced Safety: By alerting the pilot to the early signs of fatigue, the fatigue detection system 100 contributes to the overall safety of the flight by enabling timely interventions.
4. Customizable Feedback: The fatigue detection system 100 can be configured to vary the vibration patterns or intensity based on the severity of the detected fatigue, providing a graded alerting system that communicates the urgency of the situation to the pilot.

The inclusion of the haptic feedback mechanism within the WBS is a technical solution that addresses the need for an alerting system that is both effective and non-intrusive. By leveraging the sense of touch as a communication channel, the fatigue detection system 100, in some examples, ensures that pilots receive fatigue alerts in a manner that respects the demands of the flight deck and enhances the pilot's ability to maintain optimal alertness levels.

Data Privacy and Security: The fatigue detection system 100, in some examples, implements data privacy and security, including measures to protect sensitive pilot data from unauthorized access, including by employers. The system's approach to handling and storing data is designed to respect the privacy of pilots and comply with data protection regulations.

The wearable biometric sensor (WBS), such as the wristband 102, collects biometric data for assessing the pilot's fatigue level. To ensure the privacy and security of this data, in some examples:
Local Data Storage: The fatigue detection system 100 processes and stores the biometric data locally on the pilot's device, as indicated by the local storage 130 within the data storage 128. This means that the data is not transmitted to external servers or stored in the cloud, where it could be more vulnerable to breaches.
No Employer Access: The fatigue detection system 100 may be configured to prevent employer access to the footage captured from the cameras and the biometric data collected by the wristband 102. This measure is put in place to maintain the trust of the pilots and ensure that their sensitive information is not used for purposes other than fatigue detection.
End-to-End Encryption: When data is transmitted, such as for sending fatigue metrics to an airline for analysis, it is protected by end-to-end encryption. This ensures that the data remains secure throughout its transmission path and can only be decrypted by the intended recipient.
Opt-Out Option: Pilots have the option to opt-out of releasing their data for purposes such as model training. This gives pilots control over their personal information and the choice to participate in data sharing.
Secure Communication Protocols: The fatigue detection system 100 employs secure communication protocols, such as those managed by the Flask API 136 within the backend infrastructure 132, to handle data transmission securely and reliably.
Compliance with Regulations: The fatigue detection system 100 is developed with a focus on compliance with relevant privacy regulations and standards, ensuring that the fatigue detection system 100 meets legal requirements for data protection and privacy.

By prioritizing data privacy and security, the fatigue detection system 100 seeks to address potential concerns that pilots may have regarding the use of their personal data. The technical solutions implemented within the fatigue detection system 100, in some examples, such as local data storage, encryption, and secure communication protocols, provide pilots with the assurance that their data is handled responsibly and with the utmost care for their privacy.

Fatigue Trend Analysis and Reporting: The fatigue detection system 100's analytics and reporting layer plays a role in processing collected data to identify trends in pilot fatigue, in some examples. This capability may be helpful for providing airlines with actionable insights that can inform scheduling and fatigue management strategies, ultimately enhancing pilot well-being and flight safety.

The analytics and reporting layer 246, which includes the fatigue trend analysis module 248 and the reporting module 250, performs several example functions:
Trend Analysis: The fatigue trend analysis module 248 processes accumulated data over time to identify patterns and trends in pilot fatigue. This analysis may reveal correlations between fatigue incidents and specific flight segments, times of day, or pilot schedules.
Data Visualization: The reporting module 250 transforms the insights generated by the fatigue trend analysis module into visual reports. These reports may include graphs, heat maps, and charts that highlight key findings, making it easier for airline management to interpret the data.
Customizable Reports: Airlines can customize the reports to focus on particular areas of interest, such as comparing fatigue levels across different pilot bases or aircraft types. The reporting module 250 can format and export reports in various file formats for ease of use.
Operational Decision-Making: The data and trends identified by the fatigue detection system 100 can be used by airlines to optimize pilot work schedules, implement fatigue risk management systems, and make informed decisions about training and operational procedures.
Feedback Loop: The fatigue detection system 100 allows for a feedback loop where data from the fatigue detection system can be used to refine and improve the algorithms and models used for fatigue assessment, leading to continuous improvement in the system's accuracy and reliability.
Compliance with Regulations: The analytics and reporting layer 246 is designed to comply with aviation industry regulations and standards, ensuring that the data handling and reporting practices meet all legal requirements.

By providing a sophisticated analytics and reporting layer, the fatigue detection system 100 enables airlines to proactively manage pilot fatigue. The insights gained from the system's trend analysis can lead to more effective fatigue management strategies, such as adjusting flight schedules, implementing rest requirements, and providing targeted fatigue management training. This not only contributes to the health and safety of pilots but also promotes the overall operational efficiency and safety of airline operations.

Scalability and Flexibility: The fatigue detection system 100, according to some examples, has a modular design, which provides the scalability and flexibility to integrate additional sensors or data sources. This adaptability may help meet the specific needs of different aircraft configurations and comply with varying regulatory environments.

Example aspects of system 100's scalability and flexibility include:
Modular Architecture: The system's architecture, as depicted in the layered views of FIG. 1 and FIG. 2, is designed to be modular. This means that individual components, such as the data acquisition layer 202, the core analysis layer 214, and the integration layer 228, can be updated or replaced without affecting the entire system.
Integration of Additional Sensors: The fatigue detection system 100 can accommodate various types of biometric sensors beyond the heart rate monitor and ECG sensors included in the wristband 102. For example, it could integrate sensors that measure temperature, blood oxygen saturation (SpO2), or even galvanic skin response (GSR), depending on the specific requirements of the airline or the regulatory body.
Compatibility with Different EFBs: The electronic flight bag (EFB) application 112 is designed to be compatible with different models of EFBs, which may be used by various airlines. This ensures that the system can be deployed across a wide range of aircraft types and EFB platforms.
Adherence to Regulatory Standards: The fatigue detection system 100 may be configured to comply with the regulations of different aviation authorities. This includes tailoring the fatigue detection system 100 to meet the specific data protection, privacy, and operational standards required in different jurisdictions.
Customizable Alerting and Reporting: The decision and alerting layer 218 and the analytics and reporting layer 246 can be customized to provide alerts and reports that are aligned with the airline's operational protocols and fatigue management strategies.
Ease of Maintenance and Updates: The backend infrastructure 132, including the Python backend 134 and the Flask API 136, allows for easy updates and maintenance of the system's software components. This ensures that the fatigue detection system 100 can evolve over time to incorporate new technologies and data analysis techniques.

By offering scalability and flexibility, the fatigue detection system 100 may be implemented by different airlines with varying fleet sizes and operational needs. The system's ability to adapt to new sensors and data sources, as well as to different regulatory requirements, makes it a versatile solution for managing pilot fatigue across the aviation industry.

### Example Use Case

### Use Case 1: Real-Time Fatigue Monitoring During Flights

Pilots are equipped with a wristband that includes sensors to monitor biometric data such as heart rate and heart rate variability (HRV) in real-time. The fatigue assessment engine 216 analyzes this data to determine the pilot's level of fatigue during flight operations. This process is depicted in the system architecture shown in FIG. 14A, where the wristband sensors capture and send data to the fatigue assessment engine for analysis.

### Use Case 2: Night Flight Fatigue Detection

For flights that occur during nighttime or in low-light conditions, an infrared camera is used to capture facial imagery of the pilot. The facial recognition software 122 processes this imagery to detect signs of fatigue, even when standard cameras may not provide clear images. The integration of the infrared camera and its role in fatigue detection is illustrated in FIG. 3 and FIG. 4.

### Use Case 3: Personalized Fatigue Mitigation Advice

Based on the detected fatigue level, the fatigue detection system 100 generates personalized advice for the pilot, which is displayed on the electronic flight bag (EFB) application. This advice is tailored to the pilot's specific situation and flight details, as shown in the flowcharts of FIG. 12 and FIG. 13, ensuring that the recommendations are relevant and actionable.

### Use Case 4: Fatigue Trend Analysis for Airline Scheduling

The fatigue detection system 100 sends collected fatigue metrics to the airline's database for trend analysis. The analytics and reporting layer processes this data to identify patterns that can inform pilot scheduling and fatigue management strategies. The data analysis and reporting process are detailed in FIG. 19.

### Use Case 5: Pre-Flight Fatigue Assessment

Before a flight, pilots use the fatigue detection system 100 to assess their current fatigue levels. The camera and wristband collect facial imagery and biometric data, respectively, which the fatigue detection system 100 analyzes to provide an assessment through the EFB application. This pre-flight check may be helpful for ensuring pilot readiness before takeoff.

### Use Case 6: Post-Flight Fatigue Data Analysis

After completing a flight, the fatigue detection system 100's collected data is analyzed to provide insights into the pilot's fatigue levels throughout the flight. The fatigue trend analysis module processes the data to generate post-flight reports, offering valuable feedback for future fatigue management.

### Use Case 7: In-Flight Alerting for Fatigue Mitigation

If the fatigue detection system 100 detects fatigue levels exceeding safe thresholds, it triggers an alert to the pilot in real-time. The wristband's haptic feedback mechanism vibrates to notify the pilot, prompting immediate actions to mitigate fatigue. The alerting process is outlined in FIG. 14A and FIG. 14B.

### Use Case 8: Training and Simulation

The fatigue detection system 100 may be used in training and simulation environments to educate pilots on recognizing fatigue symptoms and appropriate responses. The feedback provided by the fatigue assessment engine and scoring module during simulations helps pilots learn effective fatigue management techniques.

### Use Case 9: Regulatory Compliance and Reporting

The fatigue detection system 100 generates reports that assist airlines in complying with aviation authority regulations regarding pilot working hours and fatigue management. The reporting module formats the data for regulatory submissions, ensuring that airlines meet compliance standards.

Each use case demonstrates the practical applications of the fatigue detection system 100 and its components, as depicted in the referenced figures. The system's modular design, detailed in the figures, allows for the integration of additional sensors or data sources, making it adaptable to various aircraft configurations and regulatory environments. This scalability and flexibility are useful for the system's effectiveness across the aviation industry.

### EXAMPLES: SET 1

Example 1 is a method for detecting pilot fatigue, comprising: capturing biometric data from a pilot via a wearable biometric sensor (WBS) integrated into a wristband; analyzing the captured biometric data to determine a fatigue level of the pilot; and providing an alert to the pilot via a haptic feedback mechanism in the wristband when the fatigue level exceeds or transgresses a predetermined threshold.

In Example 2, the subject matter of Example 1 includes, generating personalized fatigue mitigation advice based on the determined fatigue level; and displaying the personalized fatigue mitigation advice on an electronic flight bag (EFB) application accessible to the pilot.

In Example 3, the subject matter of Example 2 includes, wherein the personalized fatigue mitigation advice includes at least one of: a recommendation for taking a controlled rest; a suggestion to consume caffeine; or an instruction to engage in physical activity.

In Example 4, the subject matter of Examples 1-3 includes, capturing facial imagery of the pilot using a camera; analyzing the captured facial imagery for signs of fatigue; and incorporating the analysis of the facial imagery into the determination of the pilot's fatigue level.

In Example 5, the subject matter of Example 4 includes, wherein the signs of fatigue analyzed from the facial imagery include at least one of: yawning frequency; blink rate; or eyelid closure percentage (PERCLOS).

In Example 6, the subject matter of Examples 4-5 includes, wherein the camera is an infrared camera configured to capture facial imagery in low-light conditions.

In Example 7, the subject matter of Examples 1-6 includes, sending fatigue metrics derived from the analyzed biometric data to an airline for analysis; and enabling the airline to use the fatigue metrics to make adjustments to pilot scheduling for improved wellbeing.

In Example 8, the subject matter of Example 7 includes, wherein the fatigue metrics include at least one of: time instances when the pilot's fatigue level was logged; duration and frequency of detected fatigue signs; or identification of the pilot associated with the logged fatigue metrics.

In Example 9, the subject matter of Examples 1-8 includes, wherein the biometric data includes at least one of: heart rate data; heart rate variability (HRV) data; or electrocardiogram (ECG) data.

In Example 10, the subject matter of Examples 1-9 includes, wherein the haptic feedback mechanism in the wristband is configured to vary the intensity and pattern of vibrations based on the severity of the detected fatigue level.

Example 11 is a system for detecting pilot fatigue, comprising: a wearable biometric sensor (WBS) configured to be worn by a pilot and to capture biometric data; a haptic feedback mechanism integrated into the WBS for providing an alert to the pilot; an electronic flight bag (EFB) application configured to display personalized fatigue mitigation advice; and a processor configured to analyze the captured biometric data to determine a fatigue level of the pilot and to activate the haptic feedback mechanism when the fatigue level exceeds or transgresses a predetermined threshold.

In Example 12, the subject matter of Example 11 includes, wherein the personalized fatigue mitigation advice is generated based on the determined fatigue level and includes recommendations for actions the pilot can take to mitigate fatigue.

In Example 13, the subject matter of Examples 11-12 includes, wherein the recommendations for actions include at least one of: taking a controlled rest; consuming caffeine; or engaging in physical activity.

In Example 14, the subject matter of Example undefined includes, a camera configured to capture facial imagery of the pilot; and a facial recognition module configured to analyze the captured facial imagery for signs of fatigue and to incorporate the analysis into the determination of the pilot's fatigue level.

In Example 15, the subject matter of Examples 13-14 includes, wherein the signs of fatigue analyzed from the facial imagery include at least one of: yawning frequency; blink rate; or eyelid closure percentage (PERCLOS).

In Example 16, the subject matter of Examples 13-15 includes, wherein the camera is an infrared camera configured to capture facial imagery in low-light conditions.

In Example 17, the subject matter of Examples 11-16 includes, a communication module configured to send fatigue metrics derived from the analyzed biometric data to an airline for analysis; and wherein the airline uses the fatigue metrics to adjust pilot scheduling for improved wellbeing.

In Example 18, the subject matter of Examples 16-17 includes, wherein the fatigue metrics include at least one of: time instances when the pilot's fatigue level was logged; duration and frequency of detected fatigue signs; or identification of the pilot associated with the logged fatigue metrics.

In Example 19, the subject matter of Examples 11-18 includes, wherein the biometric data includes at least one of: heart rate data; heart rate variability (HRV) data; or electrocardiogram (ECG) data.

In Example 20, the subject matter of Examples 11-19 includes, wherein the haptic feedback mechanism is configured to vary the intensity and pattern of vibrations based on the severity of the detected fatigue level.

Example 21 is a method to detect fatigue in a pilot, the method comprising: capturing facial imagery of the pilot using a camera integrated into an electronic flight bag (EFB); collecting biometric data from a wearable biometric sensor (WBS) worn by the pilot; preprocessing the captured facial imagery and the collected biometric data; analyzing the preprocessed facial imagery and biometric data using a fatigue assessment engine to detect signs of fatigue; generating a fatigue score based on the analysis; and providing an alert to the pilot based on the fatigue score exceeding a predetermined threshold.

In Example 22, the subject matter of Example 21 includes, wherein the biometric data includes heart rate and heart rate variability (HRV) data.

In Example 23, the subject matter of Example 22 includes, wherein the preprocessing of the biometric data includes filtering noise from the heart rate and HRV data.

In Example 24, the subject matter of Examples 21-23 includes, wherein the preprocessing of the facial imagery includes enhancing image quality to facilitate accurate facial recognition.

In Example 25, the subject matter of Examples 21-24 includes, wherein analyzing the preprocessed facial imagery includes identifying facial movements and eye metrics associated with fatigue.

In Example 26, the subject matter of Example 25 includes, wherein the facial movements include yawning, drooping lips, or head inclinations, and the eye metrics include blink rate or eyelid movement.

In Example 27, the subject matter of Examples 21-26 includes, wherein the alert provided to the pilot includes a tactile alert via the WBS.

In Example 28, the subject matter of Examples 21-27 includes, displaying a message on the EFB with instructions for the pilot to mitigate fatigue.

In Example 29, the subject matter of Examples 21-28 includes, sending data on the incidence of fatigue to an airline for analysis.

In Example 30, the subject matter of Examples 21-29 includes, wherein the facial imagery and biometric data are not accessible to employers and are not stored in the system to ensure privacy for the pilots.

In Example 31, the subject matter of Examples 21-30 includes, wherein the fatigue assessment engine uses a machine learning model trained on a comprehensive dataset with tagged facial images containing symptoms of fatigue.

In Example 32, the subject matter of Example 31 includes, wherein the machine learning model is trained using a confusion matrix to determine the model's accuracy in detecting fatigue.

In Example 33, the subject matter of Examples 21-32 includes, wherein the fatigue assessment engine assigns points to different signs of fatigue based on their relevance, and a fatigue event is logged when the sum of points exceeds (or transgresses) a specific threshold.

In Example 34, the subject matter of Example 33 includes, wherein the points are reset after a predetermined time interval if no signs of fatigue are detected.

In Example 35, the subject matter of Examples 21-34 includes, wherein the method further comprises tailoring fatigue mitigation advice to the specific flight route, aircraft facilities, and timing based on flight information from the airline's route database.

Example 36 is a system for detecting fatigue in a pilot, the system comprising: an electronic flight bag (EFB) equipped with a camera for capturing facial imagery of the pilot; a wearable biometric sensor (WBS) for collecting biometric data from the pilot; a data preprocessing module configured to preprocess the captured facial imagery and the collected biometric data; a fatigue assessment engine configured to analyze the preprocessed facial imagery and biometric data to detect signs of fatigue; a scoring module configured to generate a fatigue score based on the analysis; and an alert module configured to provide an alert to the pilot when the fatigue score exceeds (or transgresses) a predetermined threshold.

In Example 37, the subject matter of Example 36 includes, wherein the WBS includes a heart rate monitor and ECG sensors for collecting heart rate and heart rate variability (HRV) data.

In Example 38, the subject matter of Example 37 includes, wherein the data preprocessing module includes a signal processing subsystem for filtering noise from the heart rate and HRV data.

In Example 39, the subject matter of Examples 36-38 includes, wherein the data preprocessing module includes an image processing subsystem for enhancing the quality of the facial imagery.

In Example 40, the subject matter of Examples 36-39 includes, wherein the fatigue assessment engine is configured to identify facial movements and eye metrics associated with fatigue from the preprocessed facial imagery.

In Example 41, the subject matter of Example 40 includes, wherein the identified facial movements include yawning, drooping lips, or head inclinations, and the identified eye metrics include blink rate or eyelid movement.

In Example 42, the subject matter of Examples 36-41 includes, wherein the alert module is configured to provide a tactile alert via the WBS.

In Example 43, the subject matter of Examples 36-42 includes, a display module configured to present a message on the EFB with instructions for the pilot to mitigate fatigue.

In Example 44, the subject matter of Examples 36-43 includes, a communication module configured to send data on the incidence of fatigue to an airline for analysis.

In Example 45, the subject matter of Examples 36-44 includes, wherein the system is configured to ensure that the facial imagery and biometric data are not accessible to employers and are not stored in the system to ensure privacy for the pilots.

In Example 46, the subject matter of Examples 36-45 includes, wherein the fatigue assessment engine includes a machine learning model trained on a comprehensive dataset with tagged facial images containing symptoms of fatigue.

In Example 47, the subject matter of Example 46 includes, wherein the machine learning model is trained using a confusion matrix to determine the model's accuracy in detecting fatigue.

In Example 48, the subject matter of Examples 36-47 includes, wherein the fatigue assessment engine is configured to assign points to different signs of fatigue based on their relevance, and to log a fatigue event when the sum of points exceeds (or otherwise transgresses) a specific threshold.

In Example 49, the subject matter of Example 48 includes, wherein the fatigue assessment engine is further configured to reset the points after a predetermined time interval if no signs of fatigue are detected.

In Example 50, the subject matter of Examples 36-49 includes, a flight information module configured to tailor fatigue mitigation advice to the specific flight route, aircraft facilities, and timing based on flight information from the airline's route database.

Example 51 is at least one machine-readable medium including instructions that, when executed by processing circuitry, cause the processing circuitry to perform operations to implement of any of Examples 1-50.

Example 52 is an apparatus comprising means to implement of any of Examples 1-50.

Example 53 is a system to implement of any of Examples 1-50.

Example 54 is a method to implement of any of Examples 1-50.

### EXAMPLES: SET 2

Example 1 is a method for detecting pilot fatigue, comprising: capturing biometric data from a pilot via a wearable biometric sensor (WBS) integrated into a wristband; capturing facial imagery of the pilot using a camera integrated into an electronic flight bag (EFB), preprocessing the captured facial imagery and the biometric data to enhance data quality; analyzing the preprocessed facial imagery and captured biometric data to determine a fatigue level of the pilot; providing an alert to the pilot via a haptic feedback mechanism in the wristband based on the fatigue level transgressing a predetermined threshold; generating personalized fatigue mitigation advice based on the determined fatigue level; and displaying the advice on the EFB.

In Example 2, the method of Example 1 includes, wherein the personalized fatigue mitigation advice includes at least one of: a recommendation for taking a controlled rest; a suggestion to consume caffeine; and an instruction to engage in physical activity.

In Example 3, the method of Example 1-2, wherein the signs of fatigue analyzed from the facial imagery include at least one of: yawning frequency; blink rate; eyelid closure percentage (PERCLOS); drooping lips; or head inclinations.

In Example 4, the method of Example 1-3, wherein the camera is an infrared camera configured to capture facial imagery in low-light conditions.

In Example 5, the method of Example 1-4, further comprising sending fatigue metrics derived from the analyzed biometric data to an airline for analysis of pilot scheduling adjustments.

In Example 6, the method of Example 5, wherein the fatigue metrics include at least one of: time instances when the fatigue level of the pilot was logged; duration and frequency of detected fatigue signs; and identification of the pilot associated with the logged fatigue metrics.

In Example 7, the method of Example 1-6, wherein the biometric data includes at least one of: heart rate data; heart rate variability (HRV) data; and electrocardiogram (ECG) data.

In Example 8, the method of Example 1-7, wherein the preprocessing of the biometric data comprises filtering noise from the heart rate and HRV data.

In Example 9, the method of Example 1-8, wherein the haptic feedback mechanism in the wristband is configured to vary intensity and pattern of vibrations based on severity of the detected fatigue level.

In Example 10, the method of Example 1-9, wherein the preprocessing of the facial imagery preprocessing of the facial imagery includes enhancing image quality to facilitate accurate facial recognition.

In Example 11, the method of Example 1-10, further comprising a fatigue assessment engine.

In Example 12, the method of Example 11, wherein the fatigue assessment engine uses a machine learning model trained on a comprehensive dataset with tagged facial images containing symptoms of fatigue.

In Example 13, the method of Example 12, wherein the machine learning model is trained using a confusion matrix to determine the model's accuracy in detecting fatigue.

In Example 14, the method of Example 1-13, wherein the analyzing the preprocessed facial imagery and captured biometric data comprises: assigning points to different signs of fatigue based on their relevance; and logging a fatigue event based on the sum of points transgressing a specific threshold.

In Example 15, the method of example 14, wherein the points are reset after a predetermined time interval if no signs of fatigue are detected.

In Example 16, the method of Example 1-15, further comprising tailoring the fatigue mitigation advice to the specific flight route, aircraft facilities, and timing based on flight information from the airline's route database.

In Example 17, the method of Example 1-16, further comprising displaying a message on the EFB with instructions for the pilot to mitigate fatigue.

In Example 18, the method of Example 1-17, wherein the biometric data is captured continuously during flight operations and the fatigue level is determined in real-time.

Example 19 is a system for detecting pilot fatigue, comprising: a wearable biometric sensor (WBS) configured to be worn by a pilot and to capture biometric data; a haptic feedback mechanism integrated into the WBS for providing an alert to the pilot; an electronic flight bag (EFB) equipped with a camera for capturing facial imagery of the pilot; a data preprocessing module configured to enhance the quality of the captured facial imagery and filter noise from the biometric data; a fatigue assessment engine configured to analyze the preprocessed facial imagery and biometric data to detect signs of fatigue; a processor configured to analyze the captured biometric data to determine a fatigue level of the pilot and to activate the haptic feedback mechanism based on the fatigue level transgressing a predetermined threshold; and a display module configured to present personalized fatigue mitigation advice on the EFB based on the determined fatigue level.

Example 20 is a non-transitory computer-readable medium on which computer-executable instructions are stored to implement a method comprising: capturing biometric data from a pilot via a wearable sensor (WBS) integrated into a wristband; capturing facial imagery of the pilot using a camera integrated into an electronic flight bag (EFB); preprocessing the captured facial imagery and the collected biometric data; analyzing the preprocessed facial imagery and captured biometric data using a fatigue assessment engine to detect signs of fatigue; generating a fatigue score based on the analysis; providing an alert to the pilot via a haptic feedback mechanism in the wristband based on the fatigue score exceeding a predetermined threshold; generating personalized fatigue mitigation advice based on the determined fatigue level; and displaying the advice on the EFB.

What is claimed is:

1. A method for detecting pilot fatigue, comprising:
capturing biometric data from a pilot via a wearable biometric sensor (WBS) integrated into a wristband;
capturing facial imagery of the pilot using a camera integrated into an electronic flight bag (EFB);
preprocessing the captured facial imagery and the biometric data to enhance data quality;
analyzing the preprocessed facial imagery and the biometric data for signs of fatigue to determine a fatigue level of the pilot;
providing an alert to the pilot via a haptic feedback mechanism in the wristband based on the fatigue level transgressing a predetermined threshold;
generating personalized fatigue mitigation advice based on the determined fatigue level; and
displaying the advice on the EFB.

2. The method of claim 1, wherein the personalized fatigue mitigation advice includes at least one of:
a recommendation for taking a controlled rest;
a suggestion to consume caffeine; and
an instruction to engage in physical activity.

3. The method of claim 1, wherein the signs of include at least one of:
yawning frequency;
blink rate;
eyelid closure percentage (PERCLOS);
drooping lips; or
head inclinations.

4. The method of claim 1, wherein the camera is an infrared camera configured to capture the facial imagery in low-light conditions.

5. The method of claim 1, further comprising sending fatigue metrics derived from the analyzed biometric data to an airline for analysis of pilot scheduling adjustments.

6. The method of claim 5, wherein the fatigue metrics include at least one of:
time instances when the fatigue level of the pilot was logged;
duration and frequency of detected fatigue signs; and
identification of the pilot associated with the logged fatigue metrics.

7. The method of claim 1, wherein the biometric data includes at least one of:
heart rate data;
heart rate variability (HRV) data; and
electrocardiogram (ECG) data.

8. The method of claim 7, wherein the preprocessing of the biometric data comprises filtering noise from the heart rate and HRV data.

9. The method of claim 1, wherein the haptic feedback mechanism in the wristband is configured to vary intensity and pattern of vibrations based on severity of the detected fatigue level.

10. The method of claim 1, wherein the preprocessing of the facial imagery preprocessing of the facial imagery includes enhancing image quality to facilitate accurate facial recognition.

11. The method of claim 1, further comprising a fatigue assessment engine.

12. The method of claim 11, wherein the fatigue assessment engine uses a machine learning model trained on a comprehensive dataset with tagged facial images containing symptoms of fatigue.

13. The method of claim 12, wherein the machine learning model is trained using a confusion matrix to determine accuracy of the machine learning model in detecting fatigue.

14. The method of claim 1, wherein the analyzing the preprocessed facial imagery and the biometric data comprises:
assigning points to different signs of fatigue based on their relevance; and
logging a fatigue event based on a sum of points transgressing a specific threshold.

15. The method of claim 14, wherein the points are reset after a predetermined time interval if no signs of fatigue are detected.

16. The method of claim 1, further comprising tailoring the fatigue mitigation advice to a flight route, aircraft facilities, and timing based on flight information from a database.

17. The method of claim 1, further comprising displaying a message on the EFB with instructions for the pilot to mitigate fatigue.

18. The method of claim 1, wherein the biometric data is captured continuously during flight operations and the fatigue level is determined in real-time.

19. A system for detecting pilot fatigue, comprising:
a wearable biometric sensor (WBS) configured to be worn by a pilot and to capture biometric data;
a haptic feedback mechanism integrated into the WBS for providing an alert to the pilot;
an electronic flight bag (EFB) equipped with a camera for capturing facial imagery of the pilot;
a data preprocessing module configured to enhance the captured facial imagery and filter noise from the biometric data;
a fatigue assessment engine configured to analyze the preprocessed facial imagery and the biometric data to detect signs of fatigue;
a processor configured to analyze the captured biometric data to determine a fatigue level of the pilot and to activate the haptic feedback mechanism based on the fatigue level transgressing a predetermined threshold; and
a display module configured to present personalized fatigue mitigation advice on the EFB based on the determined fatigue level.

20. A non-transitory computer-readable medium on which computer-executable instructions are stored to implement a method comprising:
capturing biometric data from a pilot via a wearable sensor (WBS) integrated into a wristband;
capturing facial imagery of the pilot using a camera integrated into an electronic flight bag (EFB);
preprocessing the captured facial imagery and the captured biometric data;
analyzing the preprocessed facial imagery and captured biometric data using a fatigue assessment engine to detect signs of fatigue;
generating a fatigue score based on the signs of fatigue;
providing an alert to the pilot via a haptic feedback mechanism in the wristband based on the fatigue score exceeding a predetermined threshold;
generating personalized fatigue mitigation advice based on the fatigue score; and
displaying the advice on the EFB.
